(19) United States
(12) Patent Application Publication
(10) Pub. No.: US 2010/0251864 A1
(43) Pub. Date: Oct. 7, 2010

(54) Compressible Material Profile Forming Tooling, Profile Assembly With, and Method of Using Same

(76) Inventors: Robert J. ROSE, Chesterfield, VA (US); Steven D. Hawkins, Midlothian, VA (US)

Correspondence Address: SMITH, GAMBRELL & RUSSELL, 1130 CONNECTICUT AVENUE, N.W., SUITE 1130, WASHINGTON, DC, 20036, US

(21) Appl. No.: 12/711,776

(22) Filed: Feb. 24, 2010

Related U.S. Application Data
(60) Provisional application No. 61/158,528, filed on Mar. 9, 2009.

(51) Int. Cl. B26D 1/00; A01B 29/00; B26D 1/12

(52) U.S. Cl. 83/13; 492/30; 83/663

(57) ABSTRACT

A tool device with projections and valley floors used in profiling material such as foam. The projections having distal recesses surrounded by rims to form flat topped products. A profiler has opposing tooling devices with one or more (e.g., stacked) tool devices and a cutter to form, for example, mirror image flat top output products including single of multi-zoned flat top surface regions with flat surface protuberances. Projections of one tooling device extend within a valley floor region surrounded by a projection of an opposing tooling device or within recesses formed in, for example, an opposing side wall of a projection of the opposing tooling device or projections designed to extend within valley floor regions between adjacent rows of projections on an opposing tooling device, inclusive of conformingly shaped valley floor regions having a common interior configuration to the exterior configuration of an opposing projection to be received.

### CROSS REFERENCE TO RELATED APPLICATION(S)

This application claims the benefit of U.S. Provisional Application No. 61/158,528, filed Mar. 9, 2009 which application is incorporated herein by reference.

### FIELD OF THE INVENTION EXAMPLE

The present invention is inclusive of a compressible material profiling tooling device as in a tooling device used with a profiler (e.g., convoluter) assembly in the profiling of a compressible material such as foam (e.g., polyurethane foam). Embodiments include tooling that facilitates the formation of relatively flat top products (e.g., flat top mattresses, mattress topper pads, cushions and the like).

### BACKGROUND

The formation of surface patterns in compressible material through use of compressible material profiling techniques, such as compressible material convolution and extraction, is known in the art as seen by the following patents (U.S. unless otherwise specified):

| | |
|---|---|
| MOORE | 795,359 |
| MOORE | 801,673 |
| DHALE | 2,902,091 |
| SCHULPEN | 3,197,357 |
| SCHULPEN | 3,431,802 |
| HUTTERMAN | 3,730,031 |
| SPANN | 4,603,445 |
| FARLEY | 4,879,776 |
| BONADDIO | 5,477,573 |
| BARR et al. | 5,534,208 |
| DeFRANKS | 7,174,613 |
| CARPENTER CO. | DE 20014598.3 (Utility Model) |

The foregoing references describe techniques utilized in surface shaping compressible and cutable material (e.g., compressible material such as felt, rubber and foam). This includes feeding a slab of the compressible material through tooling as in a counter rotating pair of die rollers having exterior material contact surfaces that are spaced apart a distance that is less than the non-compressed input slab (e.g., one or more (stacked-unbonded or laminated) layers of material). There is further provided one or more cutting devices (e.g., band saw blade(s)) that are positioned and designed to cut and enable the splitting apart of the input product into two or more output products (inclusive of waste and non-waste secondary output products).

Conventional tooling is inclusive of die rollers with a central shaft body and compressible material receiving recesses provided in one or both of the die rollers. The receiving recesses are provided by either holes formed in a smooth exterior solid body of a die roller or by recesses formed between projections extending from an interior support member as in a profile ring's or sleeve's base. There is also featured arrangements in the prior art wherein a pair of opposing die rollers have offset projection/recess combinations such that the projections of one roller in a pair come into alignment with corresponding recesses in the opposite roller at the time of rotation interfacing. This includes radial meshing and non-intermeshing projection/recess arrangements (with the latter having the compressive effect of one die roller causing conditioning of the material to form the desired surface configuration upon splitting the input slab of material without breaking the outermost circumference of the other roller).

As also seen from the above-listed references, the tooling in the prior art is inclusive of conveyor belt type tooling devices as in belts with surface projections or with surface recesses as well as the various forms of die rollers (as in solid unitary bodies and stacked roller die plates or profile rings).

### SUMMARY OF THE INVENTION

An embodiment of the invention is inclusive of a compressible material profile forming tooling device that comprises a base body having an exterior surface and a plurality of projections which extend off from the base body so as to form a plurality of valleys between the projections. The valleys are defined in part by valley floors formed by respective exposed regions of the exterior surface of the base body. Also, the projections each have an upper projection recess which is defined by an exposed projection recess floor and at least one projection rim system extending along the exposed projection recess floor, and the exposed projection recess floor of the projections is at a height above an adjacent valley floor.

An embodiment of the invention is inclusive of a tooling device that is a rotatable tool device with the exposed surface of the tool device's base body having a continuous outer profile which includes curvature, as in wherein the base body has a cylindrical configuration with said projections extending radially out from the exterior surface. For example, the tooling device of one embodiment includes a plurality of annular profile rings as tool devices, each with a base body. The profile rings are placed in a side-by-side stack arrangement to define a tooling device with each of the profile rings having some of the noted plurality of projections. Further, the projections are arranged in one embodiment in at least one repeating pattern over the exposed surface of the base body.

Also, in an exemplary embodiment the projections each have an encompassing rim configuration (e.g., a multi-sided rim configuration) that extends around a respective projection recess floor. As examples of multi-sided rim configurations, there is provided a rim configuration that includes a square rim configuration with a square shaped projection recess floor, straight and curved rim wall rim sections as in a square-convex rim configuration, a modified I-beam configuration, a nested hexagonal arrangement, and a combination hourglass and hexagonal rim configuration.

Embodiments of the invention feature projections that include opposite side rim walls forming a channel shaped, exposed projection recess floor between the opposite side rim walls. An example of such an embodiment includes one that features a base body that has a continuous outer profile with curvature and with pairs of respective rim walls defining the channel shaped, exposed projection recesses or channels spaced along the width of the tool device. These channels preferably extend continuously about the continuous outer profile of the base body, with, for example, the opposite rim walls extending in a parallel wavy pattern about the base body and with adjacent projections being spaced apart along a width of the base body to a greater extent than a width of one of the channels defined by adjacent, opposite rim walls.

Embodiments of the invention include those where the projection recess floor is positioned closer along a radial line to the valley floor than an upper edge of one of said rim walls. Additional embodiments include step down levels from the uppermost edge of a rim wall to an adjacent projection recess floor that is equal to or less than the height distance of that projection recess floor to the valley floor.

Embodiments also include arrangements wherein there are a plurality of projections with different rim configuration pattern types along the tool device (or tooling device), wherein projections of a first type comprise a first rim configuration pattern that comprises, for example, a wavy pattern configuration and projections of a second type that comprise a second type rim configuration as in one defining a multi-sided rim configuration that encloses respective projection recess floors. As an example, an embodiment includes the first rim configuration positioning the projection recess floor of each of the first type of projections closer to the base body than an uppermost rim edge while the projection floor recess of each of the second rim configuration types are placed closer to an exposed uppermost surface of the rim than to an adjacent exposed surface of the base body. As an example of an embodiment, a plurality of projections with annular (e.g., a multi-sided or circular in-configuration) rim extensions are provided that have a step down between the upper rim edge and interior projection recess floor of 20 to 50% relative to the overall projection height as in about a 40% step down (e.g., about a 0.2 inch step down in a 0.5 inch height projection). Also, the rim thickness sum in a cross-sectional direction or diametrical line is preferably less than 25% of the overall projection distance along that cross-section or diameter (e.g., a 20% summed thickness value for the rim walls). Further, the total area occupied by the projections relative to the encompassing exposed surface body's surface (e.g., valley surface) is in exemplary embodiments 35-55% as in 40-50%.

An embodiment also includes an arrangement wherein at least some of the projections have an encompassing rim configuration that continuously extends around the projection recess floor, and wherein the encompassing projections have a ratio (hr/hp) of rim height (hr) to projection height (hp) that is from 35-85%.

An embodiment includes a tool device that has an annular configuration (e.g., a cylindrical roller tool device) and the rim is defined by a pair of opposing rim walls that extend in spaced apart fashion continuously about the annular configured tool device to define a channel as the projection recess floor (with the ratio hr/hp of rim wall height to projection height being 35-85%, for example). As an example of an embodiment, a continuously circumferentially extending wavy pattern projection set is provided with about a 75% step down from the upper rim edge to the projection recess or channel floor with the channels and rims taking up less overall area than the exposed base floor area as in an about 30-40% channel and rim occupation to a 70-60% exposed recess floor occupation percentage (with the rim thickness taking up less percentage than the projection recess floor as in the rims' summed contact edge thickness being 20% or less than the overall width of the projection itself). Also, a projection height of less than an inch is illustrative as in 0.25 inch to 0.5 inch being a range illustrative of exemplary embodiments. Also, in some embodiments, the wavy channel projections have a lower height than the annular enclosed rim type projections described above, as in a 50% lower height (0.25 inch versus 0.5 inch projection height).

In an embodiment an encircling channel projection recess floor configuration is provided as in a double rim wall arranged in an annular fashion such that the inner rim wall is continuous and spaced radially inward of an outer positioned annular shaped rim wall. Thus, this arrangement is different than the above-described encircling single rim extension with interior projection recess floor as well as the continuous circumferential channels which meet back up, but only relative to a circumferential extension direction (e.g., encircling wavy pattern channels). Embodiments featuring a double rim wall annular projection include projection heights less than that of a half inch with a step down of about 50% (e.g., 50%+/−10%). This annular channel projection floor type also preferably works in conjunction with an interior positioned projection of a different rim configuration but a similar exterior shape as in an interior hexagonal shaped projection having only one encircled rim aligned with a hexagonal shaped, annular outer channel projection with a similar step down level to its annular projection recess floor.

An embodiment features, relative to a direction across a width direction of the tool device, a sequence of first valley floor portion—first projection rim section—projection recess floor—second projection rim section—second valley floor portion, and with the projection recess floor being at a higher height level relative to each of the first and second valley floor portions. Also, an embodiment features a tool device that has a circular outer periphery such that the width direction is parallel in extension with an axis of rotation in the tool device and wherein, along a circumferential path, there is a sequence of third valley floor portion—third projection rim section—projection recess floor—fourth projection rim section and fourth valley floor portion.

In an alternate embodiment the referenced two different types of projections provided on a tool device (or tooling device as when multiple tool devices are involved) can include a first projection rim configuration that includes two annular rim walls defining an annular projection recess floor with an interior one of the rim walls surrounding a tool device valley floor and a second type of projection configuration comprising a single annular rim wall defining a projection recess floor internal to the single annular rim wall with external only valley floor space in island like fashion.

The invention is inclusive of a compressible material profiler that includes a first tooling device, such as that represented by one of the above-described embodiments, a second tooling device, a support assembly which supports the first and second tooling devices as to define a compressible material reception gap between the first and second tooling devices, and a cutting device positioned to cut the input material as to produce first and second output products with at least one output product having a surface profile pattern that is flat topped based on projection rim configurations which include rimmed projection recess floors provided at a free end of the tool device projections.

In an embodiment of the profiler, the second tooling device includes tooling such as that described in the present application, as in a tooling device that has at least a compressible material contact section with corresponding projection patterning as that of the first tooling device. In an embodiment, the first and second tooling devices are arranged to have an interfacing section with valleys of the second tool device aligned with projections of the first tool device in a region of the reception gap.

An embodiment of the profiler also includes one where the first and second tooling devices are configured to form in the compressible material (that is fed within the reception gap) at least one output product with generally flat top surfacing.

An embodiment of the profiler includes one where the first and second tooling devices are configured as to define a plurality of, for example, foam protuberances in at least one output product (e.g., or multiple output products as in mirror image surface patterns in a pair of output products) with each having a generally flat upper exposed surface and adjacent valley floors with each adjacent valley floor in the output product(s) also having a generally flat exposed surface. As an example, first and second tooling devices are configured to define slight concavities in flat upper exposed surfaced protuberances and deeper valleys between respective protuberances of the profiled body of compressible material. That is, these slight concavities provide for an essentially flat output product surface at a plane lying flush with the output product's protrusions distal most surface edge. Alternatively, the projection recess floors can be designed even deeper than utilized to form slight concavities and greater depth concavities are producable with the distal most surface edging still providing a generally planar contact surface (and not a bulbous or pointed peak protuberance) in the output product(s).

An embodiment of the profiler includes a compressible foam profiler that forms one or more output products having flat or essentially flat top surfacing upon recovery from a cutting (e.g., separation) operation performed in or adjacent the reception gap where the compressible material is compressed. Thus, there is provided tooling devices (with projection recess flooring designed to remove peaks or points in the protuberances of an output product).

The invention is also inclusive of a method of profiling compressible material, that includes feeding a slab of compressible material (e.g., a unitary or multi-layer stack of the same or different types of materials as in the same or different types of a foam material) through a reception gap formed between first and second tooling devices that are spaced apart to compress the slab, and cutting the slab material while compressed by the first and second tooling devices as to form first and second output products with at least one output product having a surface pattern formed on a base.

An embodiment also includes a method wherein the slab material comprises a foam material, and the second tooling device has a projection section having a common projection configuration and pattern as that of a projection section of the first tooling device and with projections of the first tooling device being arranged to correspond with valleys of the second tooling device within a region of the reception gap such that there is formed first and second output products with sections having mirror image foam protuberance and recess surface patterns. An example includes a method wherein the profiling involves first and second tooling devices that are configured to form generally flat top surfacing in compressible material fed within the reception gap and subject to the offset projection and recess arrangement of the interfacing section as in one wherein the profiling involves first and second tooling devices that are configured as to define a plurality of foam protuberances in an output product with each foam protuberance having at least a generally (e.g., essentially) flat upper exposed surface and adjacent valley floors to provide a “flat topped” output product as in a mattress or mattress top (or some other cushioning body). This includes, for example, embodiments with the first and second tooling devices configured to define slight recesses (e.g., a slight concave profile) in the essentially flat upper exposed surface of said protuberances and corresponding slight protuberances (e.g., slight convex profile) in the essentially flat valley floor adjacent the protuberance.

### BRIEF DESCRIPTION OF THE DRAWINGS

FIG. 1 illustrates a perspective view of a conventional profiler (e.g., convoluter) assembly;

FIG. 2 illustrates a schematic view of a conventional profiler (e.g., convoluter) assembly's tooling and cutting device relative to a fed through slab;

FIG. 3 illustrates the output side of a conventional assembly like that of FIG. 1;

FIG. 4 illustrates a further processing of the output product from a conventional convoluter in accordance with a conventional process to achieve a flat topped foam pad;

FIGS. 5A, 5B and 5C illustrate depictions of conventional tooling and profiled output products for that tooling;

FIG. 6 shows conventional tooling used for forming in the output product's integrated, multiple patterned zones based on the tooling patterns shown in FIGS. 5A, 5B and 5C;

FIG. 7 shows an end elevational view of a tool embodiment of the present invention (e.g., a “square flat top pattern tool device”);

FIG. 8 shows an example of the footprint (or “unwrapped pattern”) of the tool embodiment of FIG. 7;

FIG. 9A shows a cut-away view of one of the projections (e.g., posts) of the tool embodiment as represented by cross-section line I-I in FIG. 8;

FIG. 9B shows a top plan close-up view of the top portion of the projection or post shown in FIG. 9A;

FIG. 10 shows a partial view of a pair of counter rotating compression rollers and the surface pattern of a section of one of the output products with the left side featuring a FIG. 8 checkerboard like “square” tooling pattern output product (and the right side a “concave square” pattern);

FIG. 10A shows a schematic cross-sectional view depiction of a pair of compression rollers having patterns (offset) like that of FIG. 8, and with a monolithic slab of foam material being drawn through a gap between the rollers, compressed and cut;

FIG. 10B shows an enlarged view of the referenced central region in FIG. 10A;

FIG. 10C shows an enlarged view of the referenced central region in FIG. 10B;

FIG. 10D shows a break out, schematic illustration of a portion of interfacing output product sections following cutting and return of the elastic material to a relaxed state;

FIG. 11 shows a top perspective view of an output product of a profiler assembly with the results of implementation of a set of offsetting tool devices having the tooling footprint of FIG. 8 shown on the left side of the output product;

FIG. 12 shows a top plan view of that which is shown in FIG. 11;

FIG. 13 shows a side elevational view of a portion of that which is shown in FIG. 11 (where one output product surface configuration blends into the other type of surface configuration);

FIG. 14 shows an end view of an alternate tool embodiment of the invention (e.g., a “vertical wave” tool device) of the invention;

FIG. 15 shows the footprint of the tool embodiment shown in FIG. 14 (e.g., a “vertical wave” pattern);

FIG. 16 shows a cut-away view taken along cross-section line II-II in FIGS. 14 and 15;

FIG. 16A shows an enlarged view taken of circled section A in FIG. 16;

FIG. 17 shows a view of the tooling and one of the output products produced in accordance with the tooling shown in the FIG. 15 footprint;

FIG. 18 shows a top perspective view of the output product surface depicted in FIG. 17;

FIG. 19 shows an end view of an alternate tool embodiment of the invention which is referenced as a “concave square” tool device for ease of reference;

FIG. 19A shows a cross-sectional view along cross-section line B-B in FIG. 19B;

FIG. 19B shows a top plan view of a square-concave projection;

FIG. 20 shows the footprint of the tooling embodiment shown in FIG. 19 (e.g., referenced as a “concave square” tool pattern for convenience);

FIG. 21 shows a cut-away view of the tooling embodiment which is taken along cross-section line III-III in FIG. 19;

FIG. 22 shows a partial view of one of the compression rollers and a portion of one of the output products featuring an output product produced by the “concave square” tooling pattern of FIG. 20 with the concave square pattern shown to the left and the below-described hexagonal-hourglass pattern to the right;

FIG. 23 shows a top plan view of the output product shown in FIG. 22;

FIG. 24 illustrates an end view of an alternate tool embodiment of the invention (referenced as a “nested hexagonal” tool device for convenience below);

FIGS. 25A and 25B show the footprint of a complementing or matching tooling set of that which is shown in FIG. 24 (e.g., referenced as first and second offset tooling patterns for a “nested hexagonal” convoluted output product);

FIG. 26 shows a cut-away view taken along cross-section line IV-IV of FIG. 24;

FIG. 27 illustrates a top plan close-up view of the top of the projection featured in the middle row of the footprint pattern in FIG. 25A;

FIG. 27A shows a cross-sectional view taken along cross-section line V-V of a top region of a post such as that shown in full in FIG. 27;

FIG. 28 illustrates a top plan close-up-view of the top of the hexagonal projection featured in the middle row of the footprint of FIG. 25B;

FIG. 28A shows a cross-sectional view taken along cross-section line VI-VI of one of the interior hexagonal projections which are received by the annular configured tooling shown in FIG. 27;

FIG. 29 shows a partial view of a set of the compression rollers and a portion of the output product produced thereby, with the left side featuring an output product section produced by the “nested hexagonal” tooling pattern of FIGS. 25A and 25B (and with the right side illustrating an additional view of a “square” pattern);

FIG. 30 illustrates an end view of an alternate tool embodiment (referenced as “hexagonal—hourglass” tool device for convenience);

FIG. 31 shows the footprint pattern for the tooling shown in FIG. 30 (e.g., referenced as a “hexagonal—hourglass” tooling pattern for convenience);

FIG. 32 shows a cross-sectional view of the tooling at a location on the tooling device represented by a cross-section line VII-VII in FIG. 30 which extends through both a first and a second type of projection featured in the tooling pattern of FIG. 31;

FIG. 32A shows an enlarged top plan view of an hourglass rimmed projection pattern of FIG. 31;

FIG. 32B shows an enlarged top plan view of an hexagonal rimmed projection pattern of FIG. 31;

FIG. 33 shows a partial view of a counter-rotating pair of the compression rollers and the surface pattern of a section of the output product with the right side featuring an output product produced by the “hexagonal—hourglass” tooling pattern of FIG. 31 (and with the left side illustrating an additional view of a “concave square” pattern as earlier described above);

FIG. 34 shows a top plan view of the output product shown in FIG. 33.

FIG. 35 illustrates an end view of an alternate tool embodiment of the inventions (referenced as a “modified I-beam” tool device for convenience);

FIG. 36 shows the footprint of that which is shown in FIG. 35 (e.g., referenced as “a modified I-beam” tooling pattern for convenience);

FIG. 37 shows a cross-sectional view taken at a location on the tooling device represented by a cross-section line VIII-VIII in the FIG. 36 footprint pattern;

FIG. 38 shows a partial view of a pair of counter-rotating compression rollers and the surface pattern of a section of the output product with the left side featuring an output product produced by the “modified I-beam” tooling pattern of FIG. 36 (and with the right side illustrating an additional view of a “hexagonal—hourglass” pattern as earlier described above); and

FIG. 39 shows a top plan view of the exposed “modified I-beam” output product.

### DETAILED DESCRIPTION

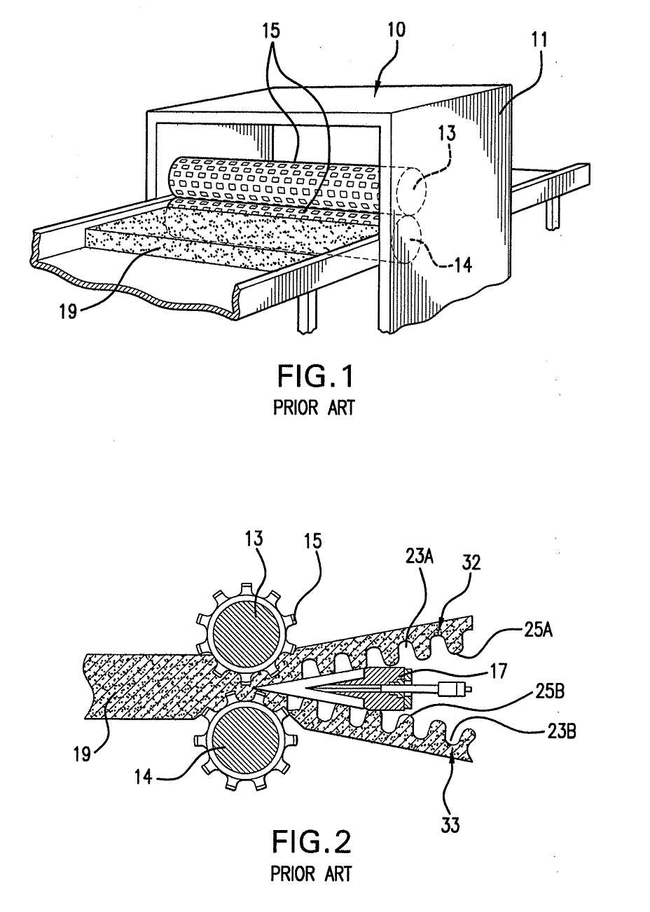

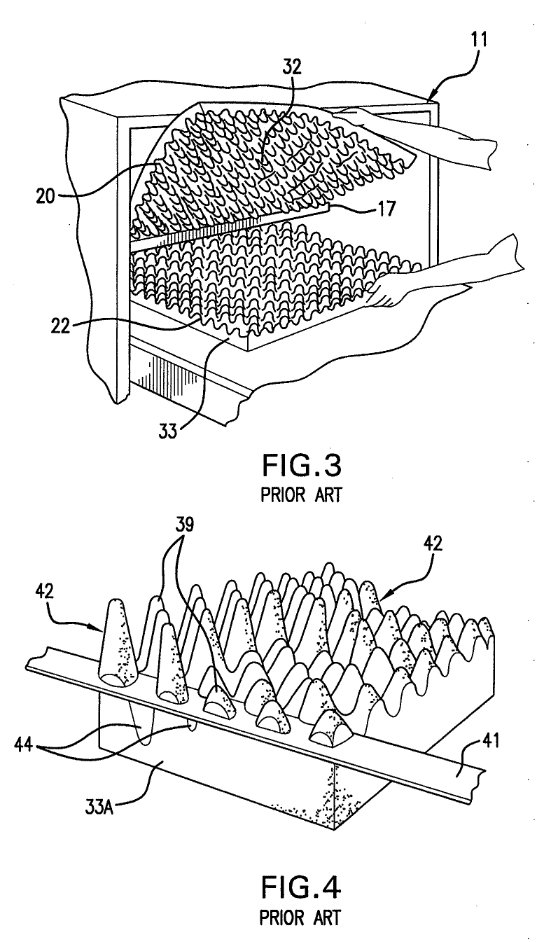

FIG. 1 shows a conventional convoluter assembly 10 with material slab 19 being fed between compression rollers 13 and 14 supported by support assembly 11 and with each having (relatively offset) fingers 15. FIGS. 2 and 3 show slab 19 being deformed by the respective profile fingers of rollers 13 and 14 and then cut by knife device 17 while being in a state of compression which results in output layers 32 and 33. Output layer 32 is shown as having a plurality of valleys 23A and peaks 25A across its newly exposed, profiled surface 20, which valleys and peaks correspond in opposing, opposite fashion with respective peaks 25B and valleys 23B on newly exposed, profiled surface 22 of opposite output layer 33.

FIG. 4 shows an additional view of a removed output layer (pad) 33A of a convoluter produced in accordance with a process described in U.S. Pat. No. 4,879,776 as to have a plurality of peaks 42 and valleys 44 of different heights/depths. In the process of U.S. Pat. No. 4,879,776 there is carried out the further step of cutting off the tops 39 of peaks 42 with band saw blade 41 to provide a substantially flat upper face. Output pads 32 and 33 are utilized in products such as mattresses pads thus providing a relatively flat upper support surface to a person lying thereon.

Convoluter assembly 10 shown in FIGS. 1 to 3 is illustrative of a conventional profile cutting machine (convoluter) such as sold by Fecken-Kirfel GmbH, of Aachen Germany. As described in the literature associated with such convoluters, typical materials described for use with such profilers include synthetic and natural rubber (e.g., combined granulated rubber), foams such as polyurethane, polyethylene, open cellular polyvinylchloride flexible foam, latex, “memory” and other foam types (including virgin, bonded, and integrated material foam products as in melamine filled polyurethane foam) and other compressible materials.

Also the literature associated with such standard convoluters provide examples of typical field of use applications as in:

A) Packaging industry (as in profiles to protect fragile goods);
B) Bedding industry (as in special profile mattresses (external or internal positioned-surfaced output products) and cushions for residential, hotel, medical, etc.);
C) Construction industry (as in rubber floors for sport arenas, padding for flooring as in rug pads); and
D) Outdoor (e.g., pads or cushions for garden furniture and deck chairs and camping industry products)

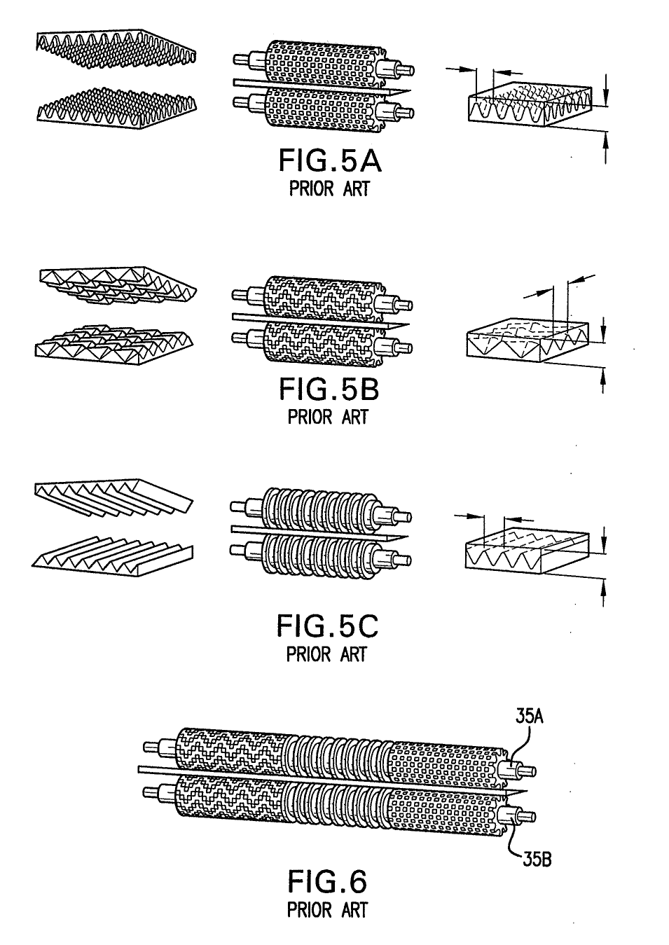

FIGS. 5A, 5B and 5C illustrate depictions of conventional tooling assemblies and output products for that tooling. FIG. 5A is illustrative of a standard “hump” surface profile tooling assembly (tooling shown in middle of this figure) and the introduction slab (right side) with the cut out pattern shown with interior lines and the actual pair of output products (left side) generated thereby. FIG. 5B is illustrative of a standard “zig-zag” surface profile tooling assembly (middle) and the introduction slab (right side) with the cut out pattern shown with interior lines and the actual pair of output products (left side) generated thereby. FIG. 5C is illustrative of a standard “sine-wave” surface profile tooling assembly (middle) and the introduction slab (right side) with the cut out pattern shown with interior lines and the actual pair of output products (left side) generated thereby.

Thus, as seen from above, standard profiles include “hump”, “zig-zag” and sine profiles, and, relative to the FIG. 2 conventional profiler, the various designs are achieved by the stacking of different profile rings along a central shaft or shafts (35A, 35B—FIG. 6). With a profile cutting machine or convoluter such as that schematically depicted in FIG. 2, slabs of different initial height can be cut into different profiles. Also, various profile rings with the same outer diameter can be combined to produce output products with different zones next to each other (e.g., a multi-zone mattress pad).

FIG. 6 illustrates conventional tooling used for forming multiple pattern zones in the output products. In FIG. 6, the tooling assembly is shown as having each of the above described tooling patterns for FIGS. 5A to 5C combined on common rotation shafts which provides for multi-zone output products with the noted different zone surface patterns (i.e., a zig-zag (bulbous) ridge sequence/a sinusoidal wave sequence/and a hump profile sequence).

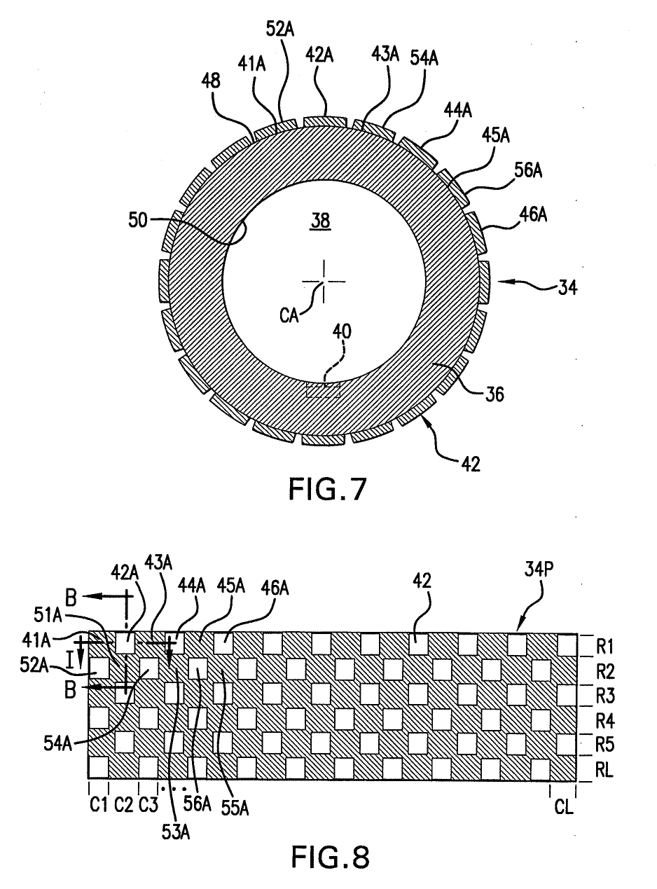

FIG. 7 shows an end elevational view of a tool device embodiment 34 of the present invention which provides a compressible material profile forming tool or means for forming a profile in a compressible material which, following a cutting or splitting operation, produces a generally predetermined pattern in the output products formed thereby (output products for use in fields such as the “typical fields” described above as well as for other uses). For convenience reference is made to a “square pattern” in the discussion below relative to the tool device 34 which is an example of an exemplary embodiment under the general subject matter of the present invention. Output layers 32 and 33 of FIGS. 2 and 3 are generally illustrative of output products from a convoluter, but fail to have the surface patterning of the present invention as made clearer by reference to the inventive embodiment examples described below.

Tool device 34 is shown in FIG. 7 as comprising tool base body 36 shown in this embodiment in the form of a cylindrical, annular body with central cavity 38 through which, for example, a suitable rotation shaft (e.g., see shafts 35A, 35B in FIG. 6) is inserted (e.g., a key slot/spline arrangement to rotationally interlock) as represented by key slot 40 shown schematically in dashed line fashion in FIG. 7, although other locking means as in bolts and the like are featured as mounting means in alternate embodiments. The illustrated embodiment shows a tooling device that is rotatably supported for contact with compressible material fed thereto. Exemplary embodiments for tool device 34 include a unitary (e.g., monolithic) tool device that extends over generally the full contact width of the compressible material or, as a further example, tooling that is comprised of a plurality of tool devices as in a plurality of cylindrical sleeves or plates or “profile rings” or the like. For example, tooling of the present invention includes tool devices (e.g., profile rings) that are stacked on a central rotation shaft (such as the noted shaft 35A (or 35B) shown in FIG. 6) to achieve the desired width such as the widths for forming relatively wide bodies as in mattress bodies or lesser width bodies as in seat cushions and the like. Also, a general discussion of stacked tooling rings is provided in German Utility Model 20014598.3 to Carpenter Co. which is incorporated herein by reference.

Thus, depending on factors such as the width of the output product, the width of the tool device and the desired width of the profiled surface in the output product, a “tooling device” under the present invention may be comprised of a single “tool device” or a plurality of “tool devices” combined to form the tooling device as in the stacking of a plurality of the same type or different tool devices (e.g., profile rings) to form a tooling device such as one of the aforementioned tooling rollers. A pair of tooling devices (e.g., each comprised of one or a plurality of tool devices, respectively), can be utilized to provide a tooling device assembly or tooling set. The term “tooling” is also used in the present application as a generic reference to any one of the above or any combination of the above tool references.

The tooling means of the present invention features the tool devices and/or tooling devices described above as well as a variety of additional embodiments in addition to those described above. This includes, for example, tooling featuring any combination or sub-combination of the tooling means described above as well as tooling means represented by tool devices or tooling devices represented by the examples A) and D) set forth below.

A) conveyor-conveyor combinations (including, for example, smooth to non-smooth patterned combinations as well as patterned to patterned combinations as in opposite and offset patterned meshing tooling on adjacent conveyor devices);

B) conveyor-tooling roller combinations (including, for example, smooth to patterned and patterned to patterned combinations with the smooth being either of the conveyor and roller components and the patterned also being one or the other or both); and

C) a sliding or stationary plate to tooling roller (or conveyor) combinations.

D) independent tooling sheets as in non-circular flexible tooling sheets fed between compressive roller devices.

Also, while a centralized, common thickness separation of an input slab is well suited for many embodiments of the invention, adjustments in the relative location of the cutting blade or separation means is also featured under the present invention as well as the inclusion of added cutting means as in two blades operating to form three output products with the same or different relative thicknesses. Further, through adjustment of the relative location of a blade to a tooling device (e.g., through operation of a blade height adjustment means found in conventional profilers) there can be achieved the placement of the cutting plane in close proximity to one of the tooling devices such that an extraction process is carried out whereby one of the two output products may constitute a waste or separate use layer and the remaining output product represents a surfaced output product body. Such blade adjustments can include an intermediate generally common split thickness range of 40-60% relative to the spacing distance at the point of maximum compression or less than 10% with the blade positioned close to an actual blade/tool device contact providing extraction settings.

Furthermore, tooling embodiments of the present invention are suited for use with materials such as one or more of the above described materials such as rubber goods, polyurethane foam (polyurethane and polyester), open cellular PVC foam, bonded foam, non-wovens, as in felt and thermobonded plastics, etc. Materials, such as those described above are illustrative but not meant to be limiting as to the material suited for contouring with the tooling of the present invention.

FIG. 7 further illustrates tool device 34 comprising projections 42A, 44A, 46A, etc. which are shown in the form of die posts preferably arranged circumferentially in equal spaced sequence along a first row R1 of tool device 34 (as represented by row R1 in the footprint of tool device 34 shown in FIG. 8). The footprint 34P of FIG. 8 shows a portion of the repeating pattern for each circumferential row R1, R2, etc. for tool device 34. FIGS. 7 and 8 show an embodiment wherein posts or projections 42A, 44A, 46A . . . etc. extend in spaced sequence about the circumference of the exterior surface 48 of base body 36 with interior surface 50 defining central cavity 38. Row two (R2) is shown as including in sequence projections 52A, 54A, 56A . . . , etc. with the row R2 projections being visible together with row R1 in the end view of FIG. 7 in view of the offset nature (relative to respective circumferential spacing) of those projections in relationship with the projections in row R1. For the illustrated embodiment there is preferably repeated the every other common projection/offset pattern so as to provide for a checkerboard like pattern in the exposed surface of the output product. Depending on the desired width of the output product, there can be provided a number of rows on each tool device (e.g., row R1, R2, R3 . . . RL—with RL being the last row on that tool device). The tool device 34 can either be already of the desired (e.g., corresponding to output product) width in and of itself or there can be a plurality of such tool devices stacked on a shaft or the like to produce tooling having the desired overall width in the output product (preferably the input product has generally a common width relative to the tooling width, although alternate embodiments include input products having a greater width than the axial extension length in the overall tooling (in which case, for example, the outer width edge(s) would not be patterned) or of lengths greater than the width of the input product being fed through the tooling set in which case the tooling would extend out past the edge(s) of the input slab during profiling).

As further seen from a comparison of FIGS. 7 and 8, the footprint 34P of tool device 34 in the illustrated embodiment features a checkerboard configuration for posts (designated 42 in general and with common reference numbers utilized in both the tool embodiment and footprint “representation” for convenience). Thus, relative to row R1, for example, there is a sequence of clearance spaces 41A, 43A, 45A, etc. circumferentially adjacent the projections (42A, 44A, 46A, etc.) which clearance spaces are shown represented by respective surface regions defined by exterior surface 48 of body 36 formed between respective posts extending along a common circumferential line about the tool device 34. Thus, in a tire tread like pattern, pattern 34P is imposed on the compressed, input material when forming the resultant output product(s) exposed surface upon tool device 34 rotating upon the input slab (e.g., a rotation of less than, equal or more than 360°). Thus, the tool devices rotate along the exterior surface of the compressed material being fed between that pair of tool devices (such as a pair of tooling device rollers having the pattern shown only in opposing projection/recess offset or mirror image fashion and preferably rotating in counter rotation fashion to draw the slab in and through the profiler).

With respect to FIGS. 7 and 8, each row's circumferential area preferably has about 20-60% of projection occupation and more preferably 25-40% with the illustrated embodiment featuring 10 posts (with an equal number of valley spacings adjacent thereto) having a footprint area occupation taking up about 30% of the overall surface area represented by row R1. The row width is represented by the left and right edges of the assigned projections to that row plus a distance 50% outward relative to the width clearance (if any) between projections of different rows.

Row R2 presents a similar arrangement as in row R1, but offset as seen in its projection-recess-projection sequence 52A-51A-54A-53A . . . etc. As seen, each row preferably has a multitude of individual projection/space combinations as in the illustrated recess-projection-recess sequence 41A-42A-43A sequence, with the number of projections and recesses shown as being the same in each row (e.g., 5 to 20 projections with 10 being shown in the embodiment illustrated as an example). The third row R3 is shown with the same configuration and spacing as row R1, while row R4 has that of row R2 and so on until the opposite end of body 36. The number of rows can be varied to suit the desired length (or width) of the tool device and/or the output product convoluted by that tool device 34 (alone or in combination with one or more additional tool devices to form the tooling device), with 6 rows being illustrative for the embodiment shown in the Figure featuring a tool device intended for use with other tool devices for wider width or length output products (e.g., one of a plurality of tool devices with the same or similar tool pattern or different tool patterns for zoning).

That is, as noted above, the desired width in the pattern of the tooling device can be achieved by stacking individual profile rings or the like having respective pattern portions. This includes the stacking of profile rings having different widths and, hence, different pattern sub-sections relative to an overall common pattern as in the checkerboard like pattern of FIG. 8. For example, profile rings are featured having a width value range of 6-12 inches (e.g., 6, 8, 9 and 10.3 inch widths being illustrative) and a sufficient number of stacked rings to achieve a desired output product's surface width profiling. As an example of an embodiment of a tooling device utilized in producing mattresses and/or mattress topper pads and the like (“mattress output product” in general), the stacked rings can be arranged to suit the width of the desired mattress output product. Examples can be seen in the width-length values for some typed mattress products (A) to (H) set forth below:

### (A) Twin Size: 39″×75″; (B) Twin Long (Twin XL): 39″×80″; (C) Full Size: 54″×75″; (D) Full Long (Full XL): 54″×80″; (E) Three Quarter Size: 48″×75″; (F) Queen Size: 60″×80″; (G) King Size: 76″×80″ and (H) California King: 72″×84″

In exemplary embodiments the tooling device is directed at the width dimension of the output product with the length dimension being obtained by the input slab length or a continuous feed and subsequent cutting at the desired length. Thus, for example, the tooling device can have a sufficient stack set to achieve a queen size width of 60″ and then suitable stacked ring modifications (e.g., addition only and/or replacement or removal only to achieve a different size as in an addition to handle a king size width or a deletion to handle a full size width). An alternate profile arrangement under the present invention includes setting up the tooling device as to cover the length dimension of the mattress produced with the feed-in direction determining the width (e.g., a 75″ axial length in the tool device, with the tooling device being rotated a sufficient amount of times to achieve the width of the desired mattress product based on a pre-sized width input slab or a longer fed slab with post cutting).

Thus, with a stack of tool devices 34, such as those in the form of cylindrical die profile rings, that are combined, there can be formed a desired width such as that covering the standard mattress and mattress topper pad sizes on the market.

While the projections and recesses can be varied in dimension and/or configuration along a row's length or from row to row, or both, in the embodiment illustrated in FIGS. 7 and 8 the projections and recesses are shown with a common configuration across the entire pattern 34P. Further, while there is featured common diameter profile rings across the width or roller axis of the tooling device (each profile ring along a roller and each roller in the tooling device (e.g., two roller pair set) having an equal external diameter in this embodiment), there can be provided varying height profile rings (e.g., different height sets) across the width of a common roller to further vary the output products' thickness level across its width or there can be variations in overall profile roller contact diameters relative to opposing tooling rollers or the like. For example, rather than having a pair of opposing equal diameter roller tooling devices, such as a tooling set comprised of a pair of tooling devices comprised of one or more tool devices 34 arranged in an opposite projection/valley relative orientation, an opposite compression roller of a set can be in a different respective diameter arrangement (as in a larger/smaller respective diameter correspondence arrangement). Also, other than offset projection/recess arrangements, other non-offset or one set projection arrangements can be utilized with tooling devices of the present invention.

Also, with reference to pattern 34P and tool device 34 in FIGS. 7 and 8 there is formed a plurality of protuberance columns in the output product(s) based on the corresponding tooling column arrangement, as in a pattern featuring 20 columns as a non-limiting example of the number of projections provided on a die roller with those columns referenced as C1, C2, C3 CL for the 360° wrap schematically represented by pattern 34P. The number of columns represented in pattern 34P can either represent the total length of the output product (e.g., one rotation for final length of output product), be less than (full length slab contact over less than a full rotation of tool device 34), or the output project can be longer than the circumferential length of the roller as by repeating, at least partially, a prior rotation's pattern application relative to a slab of material being profiled. Embodiments include rotation of patterned roller 34 sufficiently to achieve the desired length (inclusive of a product's width, length or height length) in the output product as in enough rotations (multiple whole number with or without partial turns) to cover the length of the input product (which can either be a length designed to match the intended final use or greater than and cut further downstream or only a partial profiling application in the in-fed slab). Various means can be provided for in-feeding a slab of material greater in length than the desired output product length as in providing slab material from a continuous in-feed source or a roll of the slab material or other means for extended length slab supply. For example, the pattern 34P can be repeated along an input product to achieve a sufficient length commensurate with a length of, for example, a standard mattress or mattress pad either by feeding a mattress length slab body to a profiler or by a longer source which is then later cut after the output products are formed by the profiler to achieve a desired final or intermediate output product length.

In an exemplary embodiment, the tooling device placed in contact with the slab material is made up of plurality of stacked profile rings (with at least some having a pattern such as that of tool device 34) with the stack length being well suited for use in forming surfaced (e.g., convoluted) pads having, for example, the dimensions outlined above for standard mattress products, although, as noted above the tool devices and profilers of the present invention are suited for profiling compressible material other than that utilized for mattress products.

Also, the tooling device or tooling means in one embodiment comprises a stacked set of individual profile rings having the pattern of that of tool device 34 (or portions thereof) which are combined to achieve the desired surface impression pattern in the output product. For example, to achieve a surface pattern in an output product such as a checkerboard like surface profile with a 1.0+/−0.5 inch protubearance base distance and 1.0+/−0.5 inches for the corresponding output product's valley space distance, there can be utilized a set of tooling projections of equal length in the circumferential direction, as in a set of 10 projections having widths (with generally equal sized) circumferential directional valley spacing between the projections of 1+/−0.5 inches (e.g., a 7.67 inch diameter roller tool device). In this way there can be formed a checkerboard pattern in the profiled material having generally conforming dimensions (e.g., protrusions having about a 1 inch length at their bases widths). The present invention is also inclusive of, instead of equal sized spacings in the projections and valley floors of the pattern, variations in projection and/or spacing lengths from one row to the next or along a row. The tool device of the present invention is well suited for providing foam (e.g., polyurethane including memory foam, and latex foams, etc.) mattress pads or topping pads.

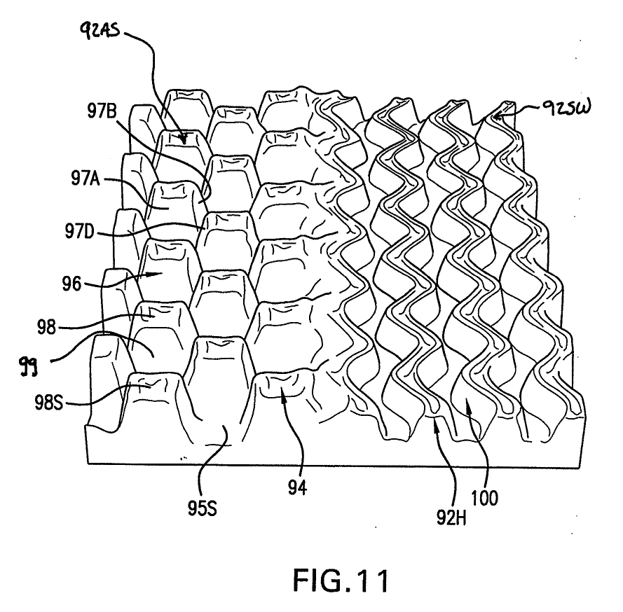

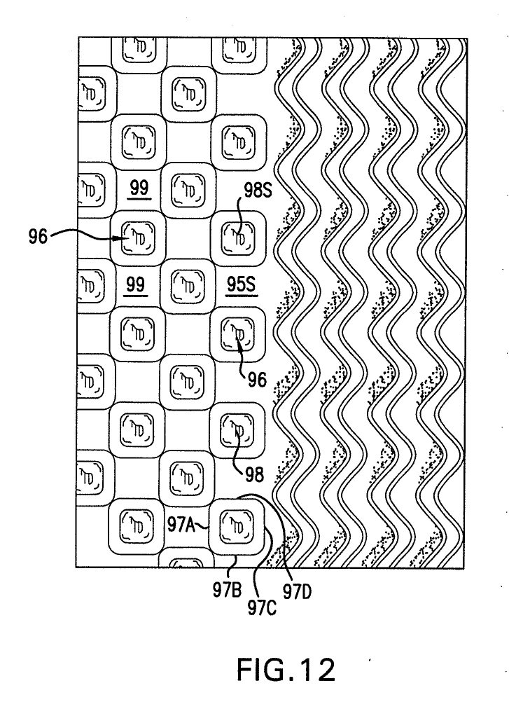

Tool devices 34 can be formed of a variety of materials including relatively heavier steel metal and, in such instances, having stacked profile rings rather than a monolithic tooling device across the full width allows for easier mobility (e.g., from the standpoint of manipulation weight of the tooling). The use of removable profile rings also provides for ready replacement of worn sections and/or an exchange with like or alternate die pattern configuration including hybrid arrangements as in different pattern profile rings on a common support shaft (e.g., shafts 35A and 35B of FIG. 6 as some examples) to provide different surface patterns across the exposed faces of the output products (e.g., see the two different hybridized surface patterns such as that shown in FIGS. 11 and 12 for the resultant output products) as well as for switching out to accommodate for different width lengths of the stack.

Also, while a single sleeve or profile ring can be provided for each zone in the profiled product (including a monolithic or single zoned output product or a multi-zoned product), embodiments include the utilization of a plurality of profile rings to provide a particular zone in the output product. Thus, there can be any number of sub-grouping of profile rings or sleeves that are assembled together to give the final “stacked” pattern (with stacked patterns including both direct side-to-side contact as well as spaced individual or groups of profile rings or the like along the length of a supporting shaft or the like). In the latter situation, there can be formed non-profiled zones between or adjacent profiled zones.

Embodiments of the invention further include tooling to produce a multi-zone pad as in an output product with one or more zones (e.g., each zone) of that embodiment presenting a relatively flat top pad surface profile, but with each or some of the zones having different profile patterns. Alternate arrangements under the invention include surface patterns with some of the zones having non-flat topping as in a sequence of flat topping and non-flat topping for at least some of the zones. In addition, through predetermined profile ring mounting and/or die patterns on the profile rings, different zones can be formed by each profile ring or individual profile rings can also define different zones in their path due to circumferential variations in the profile ring's patterning (e.g., smooth areas followed by patterned areas along a common circumferential line, etc.). There is also featured embodiments wherein one or more of the tooling patterns (and resultant output product zones) are of a different height as well as embodiments wherein all of the zones are of a common height. Embodiments of the invention further feature patterns formed on the interior region of an output product with non-patterned border rail regions extending around one or more (e.g., all) of the output product's exterior edges. This can be achieved, for example, by stacking non-patterned roller plate(s) at strategic (e.g., end) locations in the convoluting tooling with more intermediate non-smooth patterned tool devices. Similarly, there can be provided interior regions free of surface patterning by way of predetermined tooling configuring and other regions exterior to the one or more interior regions with contoured surface patterns.

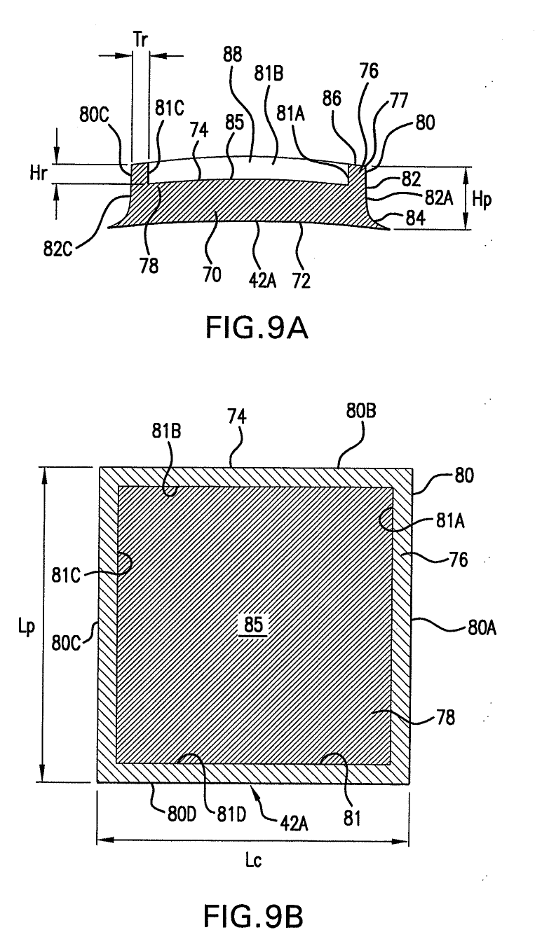

FIG. 9A shows a cut-away view of one of the projections (e.g., posts) of the tool device 34 at cross-section line I-I in FIG. 8. Thus, FIG. 9A shows post 42A in a cut-away elevational view. Also, although FIG. 8 is representative of a two dimensional pattern, for purposes of discussion FIG. 8 will be treated as though it is representative of a three dimensional track (e.g., as though the embodiment shown in FIG. 7 was cut relative to an exemplary width level and laid down like a track). Also, the cross-section of post 42A represents a universal illustration in the FIG. 7 embodiment of tool device 34 as each of the posts shown in the FIG. 8 embodiment have a common configuration.

Further, as seen in FIG. 8, cross-section line I-I is an orientation that extends relative to the circumferential direction of the tool device (if the track was in the FIG. 7 state), and thus base 70 of post 42A is shown as having a slightly curved surface 72 representing the border region with base body 46 and thus generally coincides with exterior curved surface 48 featured in the FIG. 8 view. As further shown in FIGS. 7 and 9A, in the embodiment illustrated there is preferably a monolithic arrangement between the post and body 36 relative to the profile ring tool device 34 (e.g., a profile ring formed by die press or molding techniques with an embodiment example featuring materials such as steel or other preferably relatively high precision surface forming, durable material) or, alternatively, an integrated arrangement as in securement via a weld or fastener (e.g., a releasable fastener) arrangement between the body 36 and the projections supported thereon is featured under the present invention. Also, the projections 42 themselves can be formed as an integrated arrangement as in a monolithic “post” body or as a multi-component projection inclusive of a releasably joined top portion(s) (e.g., a projection base component and a projection recessed rim component in a stack which are joined on a central fastener support, for example) which provides for switching out rim configurations relative to a common post base. The illustrated embodiments show a monolithic projection having a projection base body and a rim as explained in greater detail below, which projection is, in turn, monolithic relative to the tool device base body.

The cross-sectional view represented by II-II for post embodiment 42A is directed perpendicular to cross-section line I-I, and thus presents a similar presentation for the generally “square” profile of the projection, but for the base having a straight line relationship relative to body 36 in view of the nature of the axial extension of exterior surface 48 of the cylindrical shaped body 36 of tool device 34 (with the end view being representative of either a profile ring alone as the tooling device or one of a plurality of stacked profile rings which individually represent tool devices and in combination represent a desired tooling device).

FIG. 9B shows a top plan view of the top portion 74 (top portion only—as the base portion of the projection shown in FIG. 9A is removed in the plan view of FIG. 9B) of post 42A. As shown in FIGS. 9A and 9B, top portion 74 of post 42A features an upper extremity material contact ring or rim 76 which is shown as continuous or uninterrupted in this embodiment such that contact ring 76 extends about the periphery of the upper body portion 78 supporting the contact ring 76 (top portion 74 thus is represented in FIGS. 9A and 9B by the combination of contact ring 76 and body portion 78). The contact ring preferably extends entirely and continuously about body portion or sufficiently to provide a material capture function interior to the rim. Further, in the illustrated embodiment, contact ring 76 has a common outer wall 80 which is shown extending (height wise) in continuous or in generally uninterrupted fashion from an uppermost edge 77, down to include outer wall 82 of body portion 78 and then down to a curved fillet wall surface 84 of base 70 (or alternatively a sharp edge connection with the exposed surface of the base body).

In the illustrated embodiment outer wall 80 of ring 76 comprises, at an upper region, a set of wall sections 80A, 80B, 80C and 80D, which in this embodiment are essentially equal in length as to provide for the above described square flat top pattern, although a variety of variations (e.g., rim configurations) are featured under the present invention, some of which are described below. The underlying outer wall 82 thus has a similar set up of equal side sections as outer wall sections 80A to 80D with sections 82A and 82C being shown in FIG. 9A (i.e., two of the four referenced in that FIG. 9A).

Ring or rim 76 is further illustrated in FIGS. 9A and 9B as having interior wall 81 (with interior wall sections 81A to 81D) which also preferably extends in continuous fashion and, in the illustrated embodiment, is further shown as having a generally corresponding configuration as the corresponding upper portion of outer wall 80 (wall 81 having a slightly smaller square profile relative to the outer wall 80 due to the rim's thickness). Although alternate embodiments of the invention feature non-corresponding arrangements between inner and outer wall surfaces. As shown, ring 76 has an uppermost (exposed) rim surface 86 extending between the uppermost portion of interior wall 81 and the uppermost portion of outer wall 80 (with thickness Tr-FIG. 9A).

Also, body portion 78 has an exposed interior floor surface 85 which represents a step down projection recess floor for that projection. Interior wall sections 81A to 81D (the interior of ring 76) and exposed interior floor surface 85 thus define a material receiving cavity 88 (preferably a generally fully filled material receiving cavity upon sufficient compression relative to the material being convoluted) at the upper extremity of projection 42A. Rim surface 86 also represents in the embodiment illustrated a material first contact surface for post 42A.

As shown in FIG. 9A some of the dimensions of the top portion 74 of projection 42A include rim height Hr and projection height Hp with the cross-sectional thickness of rim 76 being referenced as Tr (all four ring segments preferably having a common thickness in this embodiment, although alternate embodiments include ring segments of different thickness about the ring periphery). While not intending to be limiting some suitable range dimensions for Hr, Hp and Tr include, 0.1 to 1.0 inches, 0.125 to 2.0 inches and 0.025 to 0.1 inches respectively; or as an additional example 0.15 to 0.3 inches, 0.2 to 1.0 inches and 0.05 to 0.075 inches respectively with 0.188 inch, 0.250 (or 0.50) and 0.063 inches respectively being well suited for some embodiments such as for convoluting foam into a checkerboard pattern.

As further seen in the projection profiles like that shown in FIGS. 9A and 9B, there is a sequence along the circumferential (and, for this illustrated embodiment, as well along the longitudinal length of the profile ring or sleeve such as that represented in FIG. 7) of a tooling valley recess floor/ a step up to the top of a projection's rim/a step-down to a projection recess exposed floor surrounded by a rim extension of the projection, a step-up to the top of a rim section on an opposing side (inclusive of circular shaped or the like opposite diameter) of the projection (preferably a portion of the same, continuous rim earlier referenced), and then a step down to another valley floor of the tooling device. In an exemplary embodiment the step down to the projection recess floor from the first rim section is smaller than the step-down from an upper edge of a rim to the valley floor defined by the exposed surface of the base body. As an example, a ratio value for Hr/Hp (which is representative of the noted step downs) of 1:4 to 2:4 is featured in embodiments of the present invention. The invention includes alternate embodiments wherein the step down is equal to the projection recess floor height off the valley floor or greater than. Also, the exposed floor of the tooling valleys and the exposed floor of the projection recess preferably are generally parallel or, in an alternate embodiment, the projection recess floor is planar and without any ring conforming curvature to the valley floor external to the projection.

As seen from FIG. 9A the upper extremity of the rim wall can have a slight curvature in the circumferential direction as in one conforming to the curvature of the exposed base body valley floor with a conforming slight curvature in the projection recess floor 85 along that circumferential direction as well while in alternate embodiments a non-curved planar surface is presented by rim edge 86. Thus, embodiments include either the rim edge 86 and/or floor 85 with a planar surface configuration, as in one that is arranged perpendicular to the rim interior wall 81.

FIG. 9B further illustrates the cross-sectional length dimension (e.g., the circumferential direction extension as in the length extension of the projection along the elongation direction of the footprint track of FIG. 8) being Lc with non limiting values suited for such a dimension being 0.5 to 10 inches, more preferably 0.75 to 3 inches with a value of 1.0±0.25 being illustrative of an embodiment of the invention. In this embodiment with a square presentation the length perpendicular to length Lc extension (length Lp) is equal in value to Lc, with Lp extending along the direction of axial extension of tool device 34. As an example of an additional embodiment of the present invention, a rectangular arrangement is presented with Lp not equal to Lc with either Lp or Lc being larger (e.g., a 25-50% differential).

Also, with reference to FIG. 9B, for example, there is seen that the relative area occupied by the rim section Ar is preferably less than 50% of the overall area Ap represented by the area defined by the outer wall at the upper extremity of rim 76 inward. An illustrative ratio Ar/Ap value range for projection 42A (as well as other embodiments under the present inventive subject matter) is, for example, 5-25% and for some embodiments 7.5-15% with a ratio value for Ar/Ap of 10+/−2% being illustrative of some embodiments of the square cross-section view shown in the FIG. 8 pattern (which can have, for example, a rim surface area of 0.15 in² and an overall area of 1.45 in² (with an interior projection floor area example being 1.45-0.15 or 1.3 in²).

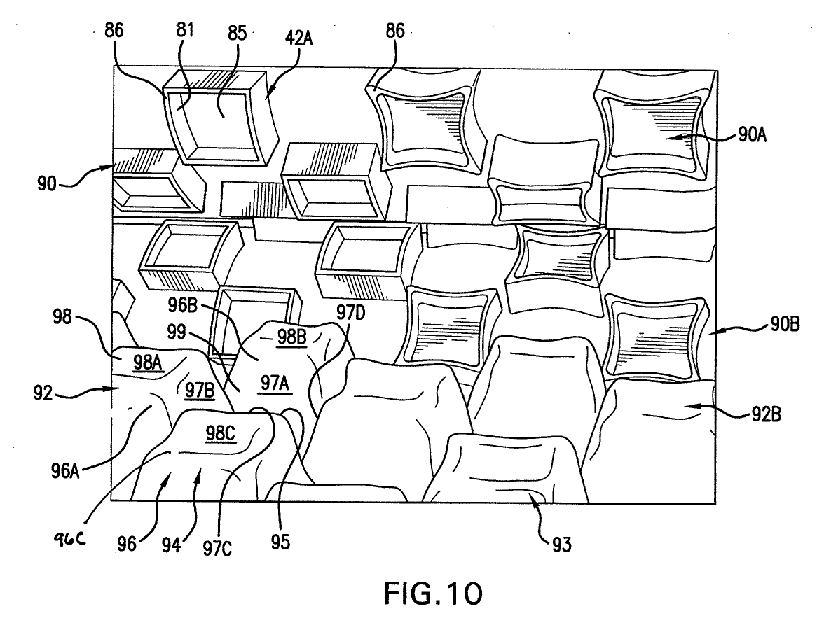

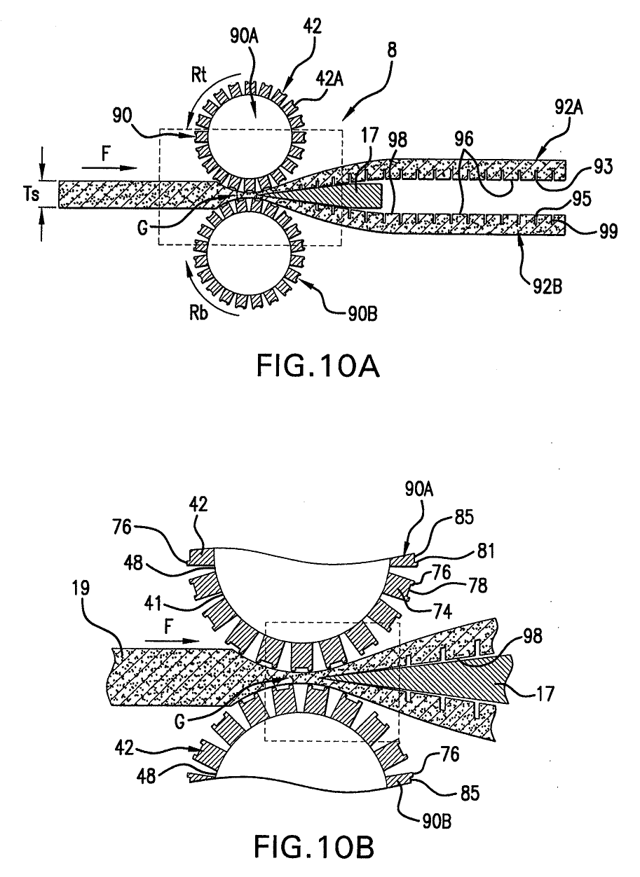

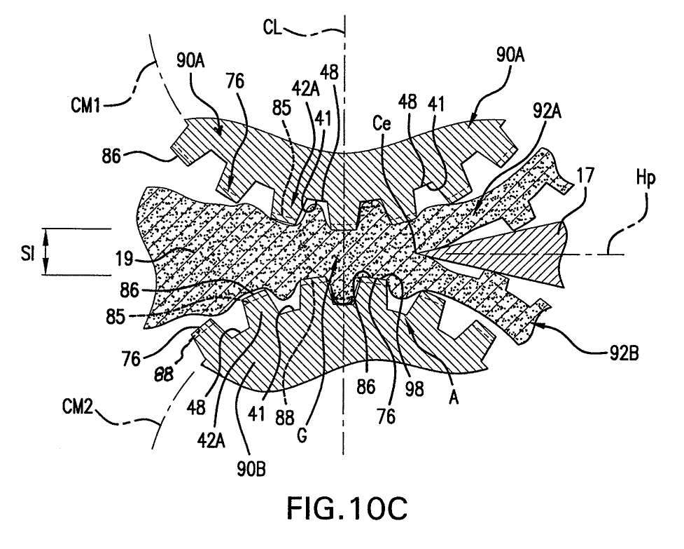

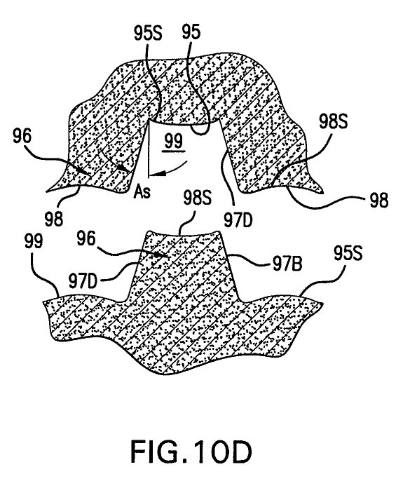

FIG. 10 shows a partial view of tooling device assembly 90 shown in the illustrated form of a compression roller set (e.g., an upper compression roller 90A and a lower position compression roller 90B) as well as a section of the exposed surface 93 of output product 92 (e.g., a section of one of two (or more) output products generated by the tooling set of rollers following cutting or splitting with FIG. 10 showing the lower positioned output product). In the FIG. 10 embodiment there is featured a hybrid pattern across the width of the roller (and hence across the width of the output product) with the left side of the roller representing a tooling pattern that has a footprint like that shown in FIG. 8 (e.g., “square flat top pattern” for the left portion) and the right side having an alternate tooling pattern (e.g., a “concave square pattern” as discussed below). As seen, the cutting results in surface pattern 94 in exposed surface 93 of that section of the output product being visible. As seen in FIG. 10, the rollers have a post pattern and post configuration similar to that shown in FIGS. 9A and 9B such that a “square flat top pattern” 94 is generated in the output product (with preferably a similar “mirror image” pattern being generated in the corresponding mirror image output product, which is not shown for improved viewing of the exposed surface of the lower output product 92B (the lower of two in the illustrated embodiment with the upper one removed from view)).

FIG. 10 further illustrates projections such as 42A with the above described outer wall 80, inner wall 81, rim surface 86 and exposed projection surface 85 in tooling 90A (e.g., an upper tooling device in a set of two as seen by 90A and 90B of FIG. 10A discussed below.) As also seen in FIG. 10, output product 92B (of a set of two as shown by 92A and 92B of FIG. 10A), which is, for example, a foam body, as in a polyurethane foam body, has pad body protuberances 96 partially defining a portion of the exposed surface 93 of output product 92B (e.g., a profiled surface in a foam pad). Further representing the exposed surface 93 are base valley surfaces 95 (the surface extending between the base of adjacent protuberances), which together with the exposed side walls 97A to 97D of protuberances 96, define the recesses or valleys 99 formed between sets of protuberances (e.g., the cavity of valley 99 is defined as being the cavity bordered on the top by an above positioned horizontal plane lying flush on the top surface of a protuberance 96 (illustrative of a flat topped surface) and the respective valley surface 95 below as well as a side wall representation comprised of extensions that incorporate the exposed side walls 97A to 97D.

Protuberances 96 (e.g., 96A, 96B, 96C . . . etc.) which generally, or to some extent, represent a reciprocal configuration as to that presented by the tooling—as in tooling recesses corresponding to output product protuberances in the area such as those shown as having a generally flat upper protuberance surface 98 (e.g., a body contact surface). Also, for the illustrated embodiment of FIG. 10, each of flat upper protuberance surfaces 98A, 98B, 98C, etc. are shown as individually having generally a common plane flat presentation surface or essentially flat top surface, and all are shown in this embodiment as presenting a generally common plane within a common protrusion configuration zone (e.g., a horizontal plane lies generally flush on each of the protuberances 98 in the zone of the embodiment shown), although alternate embodiments features different level protuberances in the same output product (e.g., a plurality of different height protuberances falling or dispersed within a common zone or common configured protuberance regions in the exposed surface of the output product or different height protuberances in respective independent zones in a common, multi-zone output product).

Reference is made to FIGS. 10A to 10C which illustrate in schematic fashion compressible material profiler or profiling means 8 with FIG. 10A showing an arrangement similar to that of FIG. 2 but with the rollers 13 and 14 having been replaced with a pair of tooling devices such as the illustrated compression roller tooling devices 90A and 90B, each with their own stack set of tool devices 34. Further the tooling devices 90A and 90B of the tooling pair are mounted in stacked fashion to achieve the desired width (e.g., a width generally commensurate with the average length or width of a desired output product as in, for example, a cushion layer in the form of a mattress layer or mattress topper). For instance, the tooling devices 90A and 90B can include tooling devices with each of sufficient axial length as to enable the formation of a cushion or similar device of a length that conforms to the typical range of height for a user. Typical adult height lengths that are often associated, for example, with one of the various standard mattress sizes such as those described earlier includes 70 to 84 inches.

The respective stacking of tool devices 34 on the tooling devices 90A and 90B is also preferably set up to achieve an offset arrangement wherein a radially extending central axis of a projection of one tool faces the central axis of a corresponding valley region of the corresponding tool device at a point of maximum compression (as in the maximum compression location represented by a plane extending through both the central axis of the lower roller and the central rotation axis of the above positioned roller and in a common axial extension direction with the blade edge preferably being at or close to the maximum compression point).

Also, in a preferred arrangement for many uses there is provided profiler means 8 receiving an elongated strip of foam that is fed to a horizontally oriented pair of rollers, although alternate embodiments of the present invention include alternate arrangements as in feeding material through a pair of vertically extending rollers, or feeding material between a pair of oblique oriented rollers, with or without the rollers' relationship being of a parallel rotation axes or one where the rotation axes are arranged in non-parallel fashion. The tooling such as 90A includes profile rings that are fixed in position in an exemplary embodiment (e.g., set screws, mounting end caps, spline and/or force fit connections, etc) to maintain the desired orientation during the profiling process. Also, in exemplary embodiments the rollers are rotated at a common speed although alternate embodiments include speed variations amongst the tooling rollers in a set. The input slab can have co-planar base and opposite surfaces prior to profiling or a different configuration as in one of those surfaces being oblique to the other.

FIGS. 10A and 10B show the pair of tooling devices 90A and 90B rotating in opposite directions as in the illustrative upper roller device 90A's counterclockwise rotation Rt and the lower roller 90B's clockwise rotation Rb to achieve the left to right feed direction F shown in FIGS. 10A and 10B. The input slab 19 is also shown in these figures as being a monolithic body as in a solid foam input pad, with alternate slab embodiments including an integrated (e.g., adhered) collection of foam particles (e.g., ground up waste foam adhered together as a common slab body) as well as additional illustrative embodiments that include laminated arrangements or simply stacked layers of similar or different material types (e.g., slab embodiments being of different materials as in a foam/non-woven stack of material (such as those that are joined together in some fashion as in heat bonding, adhesion, material integration, etc.) on similar or different materials placed in a non-joined stack as in a stacked set of different grade foam layers).

FIG. 10C provides a close up view of compressed material being fed though reception gap G with the slab of material 19 (foam shown) being subjected to a compression state with the maximum state being in the region represented by compression line CL where the relative outermost circumferences (CM1 and CM2—shown by dashed lines) are at their closest relative spacing. As further seen, at this location, the offset tooling relationship for the illustrated embodiment, places a tooling cavity 41 defined at its base by exposed tooling body surface 48 of one tooling device (90A, 90B) in general alignment with the projection 42 of an opposite tooling device (90B, 90A) with FIG. 10C showing a relative rotation state wherein upper tooling device 90A features the projection 42 along the center line and the lower tooling device 90B features the foam material cavity 41.

In an exemplary embodiment, tooling rollers 90A and 90B are rotated generally at a common rotation speed and are set apart such that the respective circumferences CM1 and CM2 are spaced apart a spacing distance S1 upon registry with the central axis CL. As further seen the spacing S1 is less than the input thickness Ts (FIG. 10A) of slab 19. The relative spacing distance S1 is preferably set to achieve the desired level of compression relative to the slab material type and thickness Ts and with the desire to achieve sufficient feed traction without excessive strain on the system due to too high a compression level imposed. Thus, the slab being fed through the reception gap G is cut by the cutting means 17 such that when a projection of a lower roller causes the compressible material to be pressed up into a concave portion of the above positioned tooling device 90A there results the formation of a cavity in the lower output product and a corresponding foam protrusion in the upper output product. In contrast, when the roller is oriented such that a projection of an upper positioned roller aligns with a lower positioned concavity in the lower roller and is cut while generally in that state (as shown in FIG. 10C), there is formed a resultant cavity in the upper output product layer and a projection in the lower output product layer upon a rebounding of the elastic material outside of the reception gap G (as shown in FIG. 10D).

Further, the relative spacing is preferably made adjustable by suitable adjustment capability in the profiler roller support structure 11. For example, while not meant to be limiting compressible material thickness Ts range of 30-250 mm (1.2-9.8 inches) is illustrative. Also, while depending on the material being compressed, the spacing range is designed to be suited for efficient (e.g., see feed through and strain discussion above) handling of slabs of foam (e.g., polyurethane foam or latex foam as a few examples). In addition, the cutting edge Ce location is preferably made adjustable relative to height along spacing S1 (e.g., a middle position provides for generally equal thickness output products or the cutting edge can be shifted up or down to render non-equal overall thickness output products including potentially thin waste layers (e.g., an extraction situation) generated when the cutting edge is moved to a maximum up or down state relative to the circumferential tooling device exterior represented by CM1 and CM2). In addition to the noted cutting edge height adjustment (or alternative to), the cutting edge Ce is made adjustable along a horizontal plane Hp such that the cutting edge is placed either upstream, at, or downstream of the CL line, with the FIG. 10C embodiment being shown positioned just downstream of the CL line while the elastic material represented by slab 19 is shown as still in a high state of compression and the cutting edge Ce generally within reception gap G.

As further seen in FIG. 10C, under the compressive impact of the opposing tooling on the slab being convoluted, the slab material is forced in some embodiments to fill or essentially or closely fill the entire recessed region (e.g., 41A, 43A . . . ) at the point where they register at the central axis CL of the tooling by the compressive effect of the projections (e.g., 42A, 44A . . . ). The level of “fill-in” is generally less for some set ups with lower compression levels. Also, the nature of the compressible material as well as the recess configuration can also have an impact on the degree of “fill-in” within cavities such as cavity 41. In addition, as further shown in FIG. 10C, material receiving cavities 88 representing the projection recesses and defined by the rims 76 and base provided by the respective exposed interior floor surfaces 85, also have an influence relative to the relative compression levels of the compressible material being received within the various reception cavities 41.

This relationship in various compression levels due to the interrelationship as to the projection extent on a tooling device and the opposing reception cavity configuration characteristics of an opposite tool device, as well as the projection recess floor configuration and step-down level is schematically represented by the above-below dash lines provided at the interior of the foam receiving cavities 41 in FIG. 10C and the associated recess 88 in the corresponding projection 42. With reference to FIGS. 2 to 4, there can be seen that with conventional finger like projections received within corresponding cavities (for many compression and feed travel levels) there results in the formation of bulbous or smooth curvature upper extremities in the resultant peaks of the output product (e.g., a hill and valley configuration). This is considered due in part to characteristics of the profile system as in, for example, one or more or all of i) the make up and elastic nature of the material, (ii) the configuration and relative positioning of the receiving cavity in the tool device, (iii) the configuration and relative positioning of the projection of the tool device, and (iv) the general relative positioning of the rollers (as in the height of the reception gap), (v) and the compression level imposed by those tool devices, etc. Embodiments of the present invention include those that are designed to help avoid or lessen the bulbous nature (e.g., foam projections with curved upper “hill profiles”) or peak nature and provide generally flat upper exposed protuberances surface (with a preference being to have flat upper surfaces or, if a variation, a variation that results in an essentially flat top exposed protrusions as in those with a relatively slight cavity extending inward in the upper region of the protrusion formed (e.g., concave depressions formed in the upper exposed surface of the projection which still leave an essentially flat surfaced protuberance at a distal end). Also, in exemplary embodiments, it is preferable to have essentially flat valley floor surfaces in the output product's exposed valley floor base regions found between protuberances (or in standard mirror image fashion raised (e.g., convex) surface regions (e.g., a slightly convex region as in one representing the opposite to the slight concave region of the adjacent protuberance) in those valley floor base body regions).

FIG. 10D shows sections of the respective output products relative to the impact of the projection and cavity combination at the center line CL shown in FIGS. 10A-10C after being cut in close proximity and travelling downstream and returning to a relaxed state.

FIG. 10C shows a first set of corresponding dash lines schematically representing, with one set, the recess formed in the upper extremity of the tooling projection and with the second set representing the lesser compression level in the compressible material while received within the tooling cavity opposite the tooling projection under consideration. Thus, there is seen, for illustrative purposes only, dashed lines extending in the temporarily projected ends of the foam material while within the interior surface of the respective receiving tool valley. Thus, with a comparison between FIGS. 10C and 10D, with the degree of compression imposed by a tooling projection (upon coming aligned with a tooling valley of an opposite roller at compression line CL) being less in its interior, stepped down projection floor area than that imposed by that projection's rim edge, there is considered to result the formation of flat top protrusions 96 (upon removal of the output products from a compression state as shown in FIG. 10D). Accordingly, there is provided a means for forming flat top protrusions in the output products without having the extra cutting requirements as seen, for example, in FIG. 4 and with a wide range of slab material input rates (or roller speed rates) and compression levels (e.g., a feed rate of up to 20 m/min or 65.6 feet/min. of input slab material which is common for some profilers).

FIG. 10D further illustrates an essentially flat top upper surface 98 in output product protrusion 96 with the slightly concave reception area 98S (e.g., a depression of less than 5 mm or less (e.g., less than 3 mm as in about 2 mm) at a point of maximum depth in the concavity). In the opposing cavity 99 there is shown a corresponding slight convex mound at valley floor 95 which is referenced as mound 95S. The slightness in the resultant concavity and convex mound is of a minor degree in exemplary embodiments as to provide an essentially flat exposed surface in the upper exposed surfaces of the output products (which is relatively far removed from the bulbous hill formations that appear in the conventional profilers such as represented in FIG. 4). FIG. 10D further shows a slight slope in the side walls of projections with wall 97D having a slope angle As of for example 30° or less (including 0°) to the vertical with 10°+/−5° being illustrative of values for the embodiment depicted in FIG. 10D. That is, as can be seen in FIGS. 10 to 13 a plurality of foam projections 96 are arranged in a generally checkerboard like pattern with each having slightly sloped walls and with each having an essentially flat top protrusion surface.

Also, the left side portions of the output products shown in FIGS. 11 to 13 provide further illustrations of the “square flat top pattern” 94. As shown therein, the recessed valleys 99 that are formed between respective surrounding sets of protrusions also preferably have the same peripheral area or one that is close to that represented by the uppermost edge of a forming projection of a tooling device (e.g., within 25%). As noted above, exemplary embodiments of the protuberances 96 of the output product 92 have an uppermost exposed surface 98 that can be considered essentially planar or flat. For example, any point on the exposed surface has less than a 10% deviation (relative to the overall height of the protuberance) from a true horizontal plane in contact with the exposed, upper surface of the protuberance 96, more preferably 5% or less with 3% or less being further illustrative of exemplary embodiment under the inventive subject matter. Any deviation from a true plane flush surface arrangement is also preferably a deviation that is inward or concave forming relative to the protuberances formed in the output product. For example, with tooling posts such as that described above in FIGS. 9A and 9B there may be formed an essentially flat, as in a very slightly concave, surface in the uppermost portion of the protuberances 96 (e.g., a concavity that is less than 5 mm in depth and more preferably less than 3 mm as in a less than 2 mm maximum depth relative to the horizontal plane lying flush on the outer edging of the projection 96). In an alternate embodiment, there is provided increased depth concavities by providing deeper positioned interior projection floor surface 85 of the above described tool projection 42A (e.g. a suction cup type configuration with polygonal edging formed in the valley surfaces which would provide a generally flat upper surface as with the protuberances having relative flat upper edging corresponding to the maximum compression rim projection formed regions with any deviation being internal and down back toward the base of the protuberance). However, as for many applications under the subject matter of the present invention, it is advantageous to have an essentially flat top surface presented by each of the protuberances in the pattern (and optionally in the valley floors) which is (are) provided with the above and below described embodiments. Also, in an embodiments, the protuberances 98 are arranged as to have a slight slope and to be close enough in relative positioning as to share common “bridging” material along the lower ½ to ⅓ of corresponding edges (corner edges) of the projections.

Examples, which are not intended to be limiting, as to possible sizes for the pads featured in FIGS. 11-13 include overall output product thicknesses of, for example, 1 to 6 inches with about 1.5 to 4 inches, with a 2 to 3 inch output product thickness being well suited for many applications and with protrusions height to base height ratios of 30-70% and more preferably 40-60% with about 50% being well suited for many application (e.g., about 4 cm for each projection height and a layer's base height of 2 cm for a 6 cm thick output product pad or a 3 cm/3 cm protrusion to base layer height being illustrative for an output product). Alternate embodiments include protrusions 96 that include heights (from valley floor to uppermost edge) of about 3 cm to 10 cm, and side wall lengths (on average) of 1.0 to 5 cms as in 2 to 3 cm width sidewalls with a combination of a protrusion height projection of 3 to 5 cms and a side wall of about 2 to 4 cms and a layer base height of 2 to 4 cms with a suitable material being a polyurethane foam material.

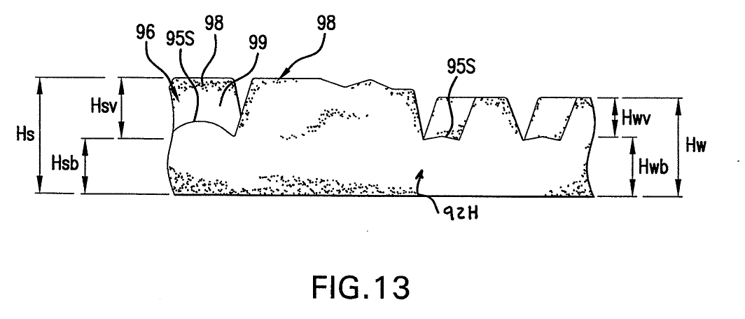

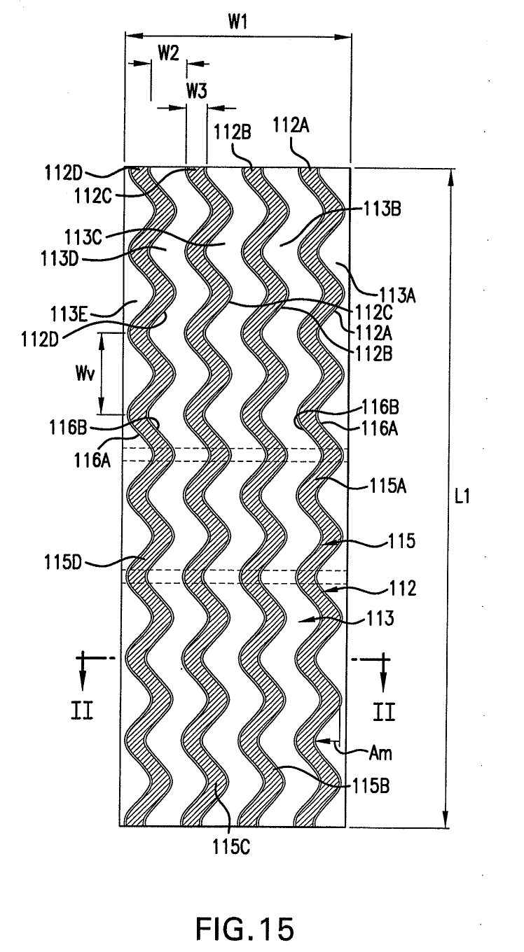

FIG. 11 shows a perspective view of the output product 92H (a hybrid double zoned protuberance pad) which has a surface pattern on the left side represented by section 92AS having a common square top configuration or pattern 94 as that shown in FIG. 10 together with a “wave” pattern 100 to the right side section 92SW which is described in greater detail below. Hence, output product 92H represents a hybrid surface pattern with two zones illustrated; namely, a square top pattern and a flat top wavy pattern. These zones in the output product being based on corresponding square flat top and flat top wavy patterns such as by the tooling pattern shown in FIG. 8 for the square flat top pattern and FIG. 15 for the wave pattern. FIGS. 12 and 13 provide, respectively, added plan and end elevational views of the output product 92H. FIGS. 12 and 13 also illustrate different level, essentially flat top protrusion surfaces provided by the different style projections in the two zones shown (e.g., square zone height level Hs represented by the distance from the base of the pad to a horizontal plane lying flush on the top of the protuberances in the square zone and the lower height Hw of the other, wavy pattern zone).

FIG. 13 further shows that there is formed respective valley depth (Hsv) and base thickness (Hsb) for the square pattern zone region 92AS of the output product, with Hsv shown in this embodiment as being generally the same as the distance for Hsb, while some illustrative (non-limiting) ratios for Hsv/Hsb being 3:1 to 1:3 with 1:1, and 2:1 being illustrative. As further seen from FIG. 13, the thickness of the output products base can be made to represent a greater percentage of the overall height of the zone Hw of the protuberances in the wavy zone (described in greater detail below) as in a ratio of Hwv/Hwb of 3:1 to 1:3 with 1:1 and 1:2 being illustrative. By varying the relative projection and valley relative dimensions, variations in base height and protuberance height can be achieved. These values can also be made independent of the results achieved by the recesses formed in the upper extremity of the tool projections which provide for the above described generally “flat top” results.

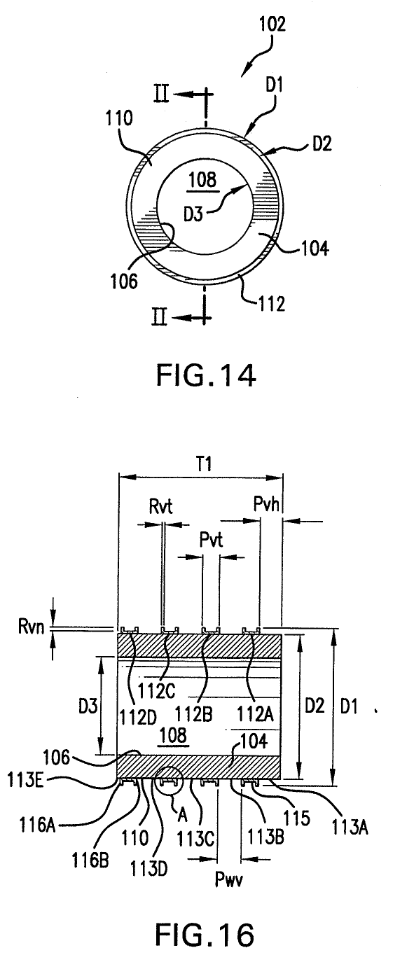

FIG. 14 shows an end view of an alternate tool device 102 of the invention (e.g., a “vertical wave” tool device) while FIG. 15 shows the footprint of the tool embodiment shown in FIG. 14. As seen from FIG. 14, tool device 102 includes base body 104 having an interior surface 106 defining central cavity 108 (for reception (e.g., splined connection) of a motorized rotation shaft or the like as described for the earlier embodiment). As also described for the earlier embodiment the end view of FIG. 14 is illustrative of an end view of a variety of tooling device types as in a unitary (e.g., monolithic) compression roller or one of a plurality of stacked profile rings.

As further seen from FIGS. 14 to 16 and 16A, extending off (e.g., radially outward) from exterior surface 110 are a plurality of projections 112 (e.g., 112A, 112B, 112C, 112D). As seen from those figures there is also a plurality of valleys 113 (e.g., 113A, 113B, 113C, 113D, 113E) positioned adjacent the projections 112 (e.g., positioned between adjacent projections) and which also represent different sections of the exterior, exposed surface 110. The individual projections 112 are shown as being circumferentially continuous in their extension about the illustrated cylindrical tool device 102. Accordingly, the recessed projection floors 115 (e.g., 115A, 115B, 115C, 115D) are shown as being circumferentially continuous and bounded only by opposite side walls that do not cross into each other (e.g., extend in parallel spaced fashion and thus this arrangement is unlike the square shaped rims of the first embodiment which rims extend in annular fashion in a polygonal configuration). Also, opposing projection rim walls 116 (e.g., 116A and 116B), present opposing interior walls 118A and 118B which border the projection recess floor 115. With the continuous nature of the projections 112, there is presented continuous and confined base body exposed surface valleys 113B, 113C and 113D between the projection. Further, as best shown by the footprint pattern presented by FIG. 15, the projections have a smooth wave, wavy configuration as in one that is of a smoothly extending sinusoidal contour. Alternate embodiments include, for example, sharper break zig-zag shaped channels as well as linear ridges.

As seen by FIG. 15 the wavy pattern presented by the projections is shared as well by the valley configurations formed therebetween. In the illustrated embodiment, there is shown the amplitude Am of the wave pattern for the tooling device as well as the wavelength Wv which can be varied to suit the desired output product's surface pattern configuration with some illustrative values being 1.5 to 6 cms for the amplitude (e.g., 2.5 cm±0.5 cm) and 2 to 20 cms for the wavelength values (e.g., 7 to 8 cms). These values correspond somewhat with the output products' wavy pattern or sinusoidal protrusion and compressibly material base valley configurations as in the above pattern producing foam protruberances of about 1 inch (2.54 cm) amplitude and about 3 inch (7.6 cm) wavelength.

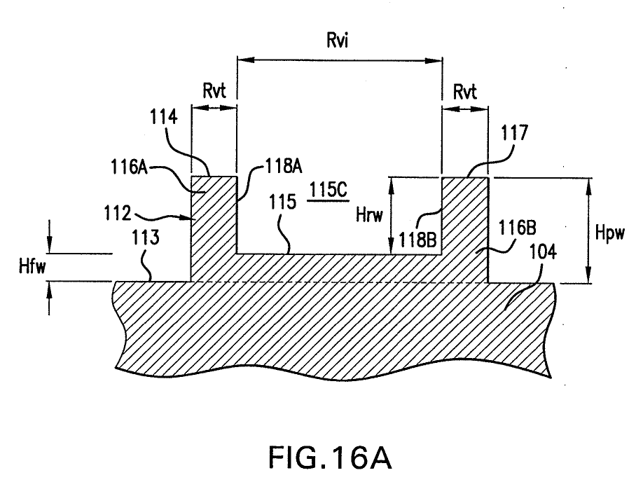

With reference to FIGS. 16 and 16A, in this embodiment the projection recess floor 115 is closer to the valley surface 113 than the upper edge 114 of rim wall 116A (which in this embodiment is at an equal level as the upper edge 117 of the opposing rim wall 116B). Also, interior wall surfaces 118A and 118B which border projection floor recess 115 are shown in this embodiment as being at right angles or vertically oriented in defining channels 115C defined by the step-down, projection recess floor 115 and the opposite interior wall surfaces 118A and 118B, although alternate cross-sectional recess or channel shapes are also featured as in inward or outward sloping sidewalls 281 or a concave depression, e.g., slight or large fillet conversion at interior walls) although the sharp break is deemed better suited for some usage situations under the present invention.

FIGS. 16 and 16A also illustrate an embodiment wherein the thickness Rvt of rim wall 118A (and also 118B in the illustrated embodiment) is less than both the minimum projection-to-projection spacing Pwv (W2 in FIG. 15) and also less than the width Rvi of floor 115.

Further illustrated in FIG. 16A is a comparison view of the overall projection height Hpw from the valley floor 113 to the upper edge of the rim wall (114, 117) as well as the height Hrw of the channel 115C (from the projection recess floor 115 to the upper edge of an adjacent rim wall (114, 117) which provides for a thickness in the channel floor 115 to the level of the valley floor 113 as Hfw. As seen for this embodiment, the Hfw height is less than the height Hrw (other embodiments such as those described above and below as well as this embodiment can alternatively feature a shallower or less pronounced step-down to the projection floor level). An illustrative ratio of Hrw/Hpw is from 50-85%, more preferably 65-80% with 75% being illustrative. Also the relative ratio of Rvt/Pvt (the rim thickness relative to the overall width of the projection) is preferably from 4-15% and more preferably 5-10% with 8% as an illustrative only ratio example as in, for example, a value of 0.063 inch (Rvt) to 0.75 inch (Pvt) as an example not intended as being limiting with Rvi thus equaling 0.75−(2)×(0.063) or 0.624 inch for this embodiment.

FIGS. 16 and 16A also illustrate the relative width of Pvt (or W3) in FIG. 15 for the projection being less than the spacing Pwv (or W2 in FIG. 15) between adjacent projections (that is the valley floor 113 width) although alternate embodiments feature an equal or opposite ratio. For example a Pvt/Pwv ratio of 3:10 to 9:10 and more preferably 4:10 to 7:10 with 6:10 as an illustrative ratio as in, for example, a value of 0.75 inch (Pvt) to 1.25 inch (Pwv) as an example not intended as being limiting.

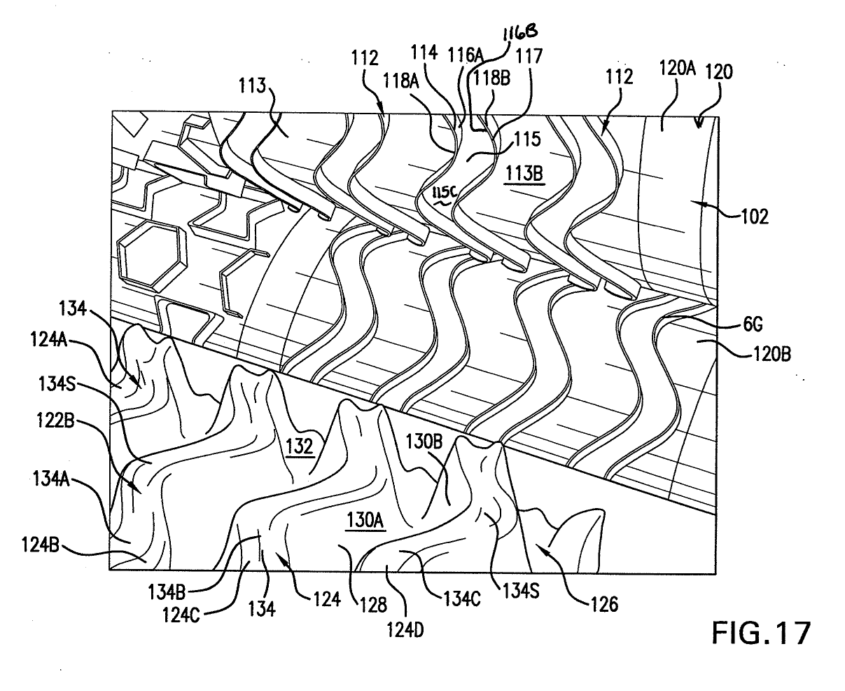

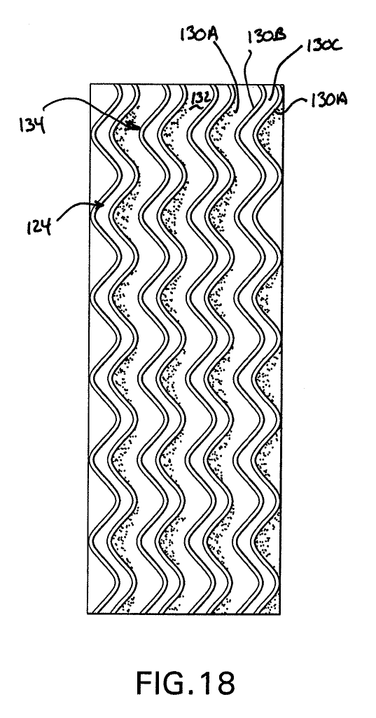

FIG. 17 shows a view of the tooling and one of the output products produced in accordance with the tooling shown in the FIG. 15 footprint. FIG. 17 thus illustrates tool device 102 with projections 112 with the above described opposing rim walls 116A and 116B, as well as the exposed upper rim edges 114 and 117 together with projection recess floor 115 (which together define projection recess channel 115C). Featured in FIG. 17 is an illustration of a portion of the tooling set 120 featuring an upper tooling device (tooling roller) 120A and a lower positioned (second) tooling device 120B (tooling roller) between which is formed reception gap 6G. Relative to each other, the opposing tooling rollers 120A and 120B are arranged, at least in the intermediate areas, to have a central circumferential line for each projection 112 of one tooling device aligned with a central circumferential line of an opposing valley recess 113. At the opposing ends of the roller devices 120A and 120B there are regions of partial wavy valley sections (113A and 113E) which preferably, if combined, represent a fully wavy pattern valley configuration such as 113B.

As also seen in FIG. 17, output product 122B (of a mirror image set of two with only the one shown), which is, for example, a foam body as in a polyurethane foam body, has pad body protuberances 124 (e.g., 124A, 124B, 124C and 124D) partially defining a portion of the exposed “wavy patterned” surface 126 of output product 122B (e.g., a convoluted surface in a foam pad). Further representing the exposed surface 126 are valley surfaces 128, which together with the exposed side walls 130A to 130B of protuberances 124, define the recesses or valleys 132 formed between a pair of side-by-side protuberances (e.g., the cavity of valley 132 is defined on the top by an above positioned horizontal plane lying flush on the top surface of a protuberance 134 (e.g., 134A, 134B, 134C, etc.), with each representing an essentially flat top surface (e.g., a “flat topped surface”), on the bottom by a valley surface 128 and by opposing side walls 130A and 130B of the side-by-side protuberances. Protuberances 124 (e.g., 124A, 124B, 124C, 124D . . . etc) which generally or to some extent represent a reciprocal configuration as to that presented by the tooling—as in tooling recesses 113B forming in the upper roller forming a protuberance like protuberance 124D. Thus, as an example of this relationship, a projection width of, for example, 0.75 inch (with thin rim walls and the channel recess therebetween, will generally produce about a 0.75 inch thick foam protrusion at its top, exposed surface).

Also, for the illustrated embodiment of FIG. 17, each of flat upper protuberance surfaces 134 (134A, 134B, 134C, etc.) are shown as individually having essentially a flat top presentment surface or essentially a common plane flat presentation surface and all are shown in this embodiment as presenting a generally common plane height level within a common projection configuration zone (e.g., a horizontal plane lies generally flush on each of the protuberances 124 in the embodiment shown), although alternate embodiments features different level protuberances in the same output product (e.g., a plurality of different height protuberances falling or dispersed within a common zone of the output product or different height protuberances in respective independent zones in a common, multi-zone output product).

FIG. 17 illustrates an additional output product embodiment 122B of the present invention formed by a tooling assembly designed to help avoid or lessen the bulbous nature (e.g., avoiding foam projections with curved or pointed upper “hill profiles”) and which preferably provides at least generally flat upper exposed protuberance surfaces (with a preference being to have an essentially flat upper surface with, if present, a variation that results in a cavity (e.g., a slight concave cavity) extending inward in the upper region of the protrusion formed (e.g., concave depressions formed in the upper exposed surface of a foam protrusion) as shown for the protrusions exposed uppermost surfaces 134. Also, in exemplary embodiments, it is preferable to have similarly at least generally flat valley floor surfaces in the output product's exposed valley floor base regions found between protrusions (as in a standard mirror image relationship with raised (e.g., convex) surface regions (e.g., essentially flat surfaced as in one with a slightly convex region) representing the opposite to the slightly concave region of the adjacent projection) being formed in those valley floor base regions.

For example, FIGS. 17 and 18 further illustrate an essentially flat top upper surface 134 in the output product 122B protrusions 124 with the slightly concave reception ridge 134S (e.g., a U-shaped in cross-section concave depression of less than 5 mm and more preferably at or less than 3 mm at a point of maximum depth in the concavity). In the opposing cavity 132 there is featured a corresponding slight convex mound at valley floor 128 which represents the reverse of the concave depression in the projection. The preferred slightness in the resultant concavity and convex mound is of a minor degree in exemplary embodiments as to provide an essential flat exposed surface in the upper exposed surfaces of the output products (which is relatively far removed in configuration from the bulbous or essentially conical pointed hill formations that appear in the conventional profilers such as represented in FIG. 4). FIG. 17 further shows a slope in the side walls of projections with wall 130A having a slope angle equal to or similar to the values of angle “As” described above for the FIG. 10D embodiment. Thus, as seen from FIGS. 14 to 17 there is formed a plurality of foam protrusions 124 that are arranged, in parallel to provide, a plurality of continuous running (full length or width of pad depending on desired orientation) wavy rows with each having vertical or slightly sloped walls and each presenting flat (or essentially flat as in upper surfaces that have the above noted minor deviations as in those represented by the above described concavities) exposed contact surfaces.

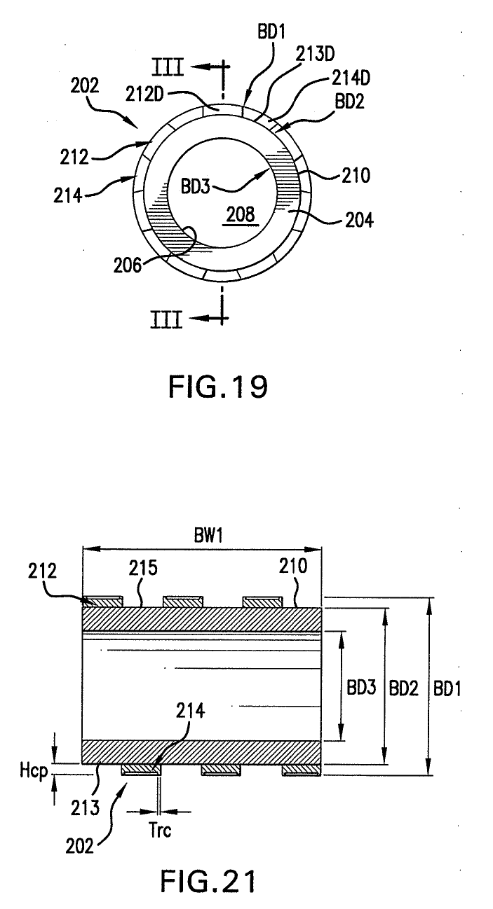

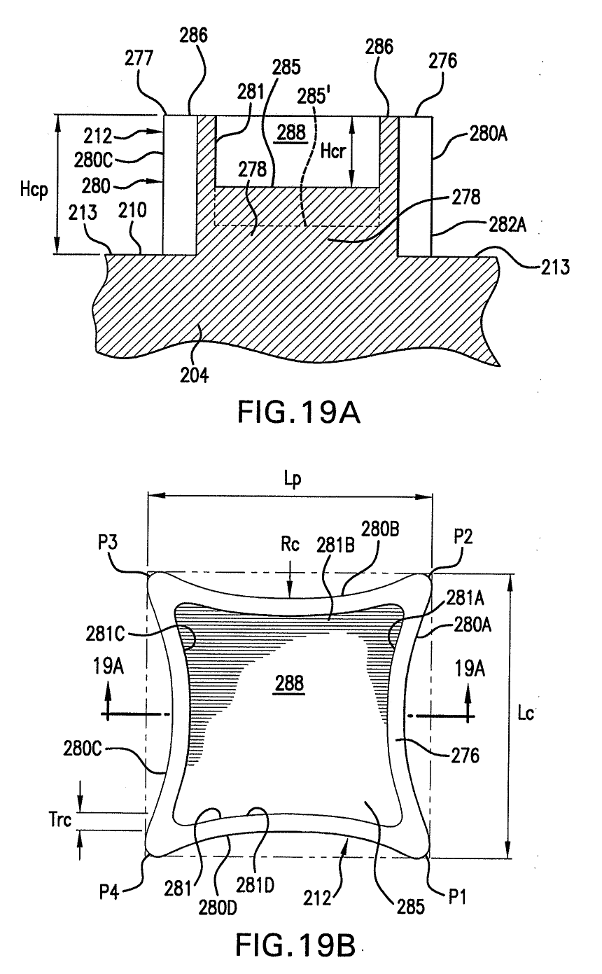

FIG. 19 shows an end view of an alternate tool device 202 of the invention (e.g., a “concave square” tool device) sharing many similarities as with the above described first embodiment, but with a different shaped and sized projection pattern as explained below. As seen from FIG. 19, tool device 202 includes base body 204 having an interior surface 206 defining central cavity 208 (for reception (e.g., splined connection) of a motorized rotation shaft or the like as described for the earlier embodiments). As also described for the earlier embodiments, the end view of FIG. 19 is illustrative of an end view of a variety of tooling device types as in a unitary (e.g., monolithic) compression roller or one of a plurality of stacked profile rings, etc.

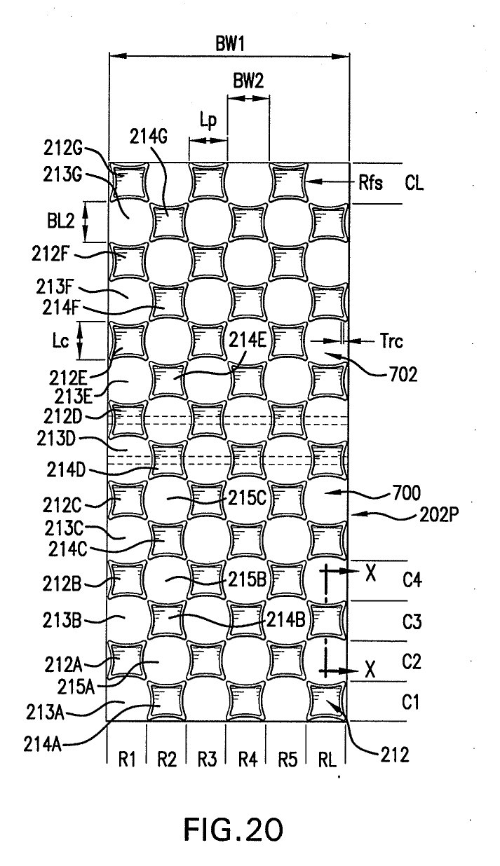

FIG. 20 shows the footprint of the tool embodiment shown in FIG. 19. As seen from FIGS. 19 to 21, extending off (e.g., radially outward) from exterior surface 210 are a plurality of projections 212 (e.g., 212A, 212B, 212C, 212D, 212E and 212F shown arranged along row R1). There is also featured a plurality of valleys with valley floors 213 (e.g., 213A, 213B, 213C, 213D, 213E, 213F, 213G—of row R1) positioned adjacent the projections 212 (e.g., positioned between or to a side of an adjacent projection) and which valley floors also represent different sections of the exterior, exposed surface 210. The individual projections 212 are shown as being circumferentially spaced apart in their extension about the illustrated cylindrical tool device 202.

The footprint 202P of FIG. 20 shows the repeating pattern for each circumferential row R1, R2, etc. for tool device 202. FIGS. 19 and 20 show an embodiment wherein posts or projections 212A, 212B. etc. extend about the circumference of the exterior surface 210 of base body 204 as row R1 with there being one or more adjacent, preferably parallel, rows as in the adjacent row two (R2). As shown in pattern 202P, row R2 also includes a plurality of projections 214 which are shown as having a staggered sequence relative to row R1. That is, there is featured a plurality of projections 214A to 214G in row R2 arranged in a spaced sequence within row R2 which align in widthwise fashion with an adjacent valley floor (e.g., 213A) in R1.

As further seen from the end view of FIG. 19, the row R2 projections (e.g., 214D are visible together with row R1 (e.g., 212D) in the end view of FIG. 19 in view of the offset nature (relative to respective circumferential spacing) of the row R2 projections relative to the projections in row R1. For this embodiment there is preferably repeated the every other common projection/offset pattern so as to provide for a checkerboard like pattern in the exposed surface of the output product. Depending on the desired width of the output product, there can be provided multiple number of rows on each tool device (e.g., row R1, R2, R3 . . . RL—with RL being the last row on that tool device). Further, the tool device 202 can either be already of the desired width (axial length) in and of itself or there can be a plurality of “tool devices” stacked on a shaft or the like to produce a tooling device having the desired overall width in the output product (preferably the input product (slab) has generally a common width as the tooling, although alternate embodiments include input products having a greater width than the axial extension length in the overall tooling (in which case, for example, the outer width edges would not be patterned) or of lengths greater than the width of the input product being feed through the tooling set).

With respect to FIGS. 19 and 20, each row's circumferential area preferably has about 25-50% of projection occupation and more preferably 30-45% with the illustrated embodiment featuring 7 posts having a footprint area occupation of about 2.5 in² taking up about 35-40% of the overall surface area represented by row R1.

As further seen in FIG. 20, each row preferably has a multitude of individual projection/space combinations as in the illustrated row R1 recess-projection-recess sequence (213A, 212A, 213B, 212B . . . etc), with the number of projections and recesses shown as being the same in each row (e.g., 5 to 20 with 7 projections 212 and 7 base body valley recesses 213 for each row being shown in the embodiment illustrated as an example). The third row R3 is shown with the same configuration and spacing as row R1 while row R4 has that of row R2 and so on until the opposite end of body 204. The second row R2 is also shown as having circular shaped valley floor recesses 215 215A, 215B . . . etc that are similarly shaped as that of the first row's 213. The number of rows can be varied to suit the desired length (or width) of the output product convoluted by tooling device 202, with 6 rows being illustrative for the embodiment shown in the Figure. Thus, with a stack of tool devices 202, such as those in the form of cylindrical die profile rings, combined, there can be formed a desired width such as that covering the standard mattress and mattress pads sizes on the market as in the manner described above for the first embodiment.

While the projections and recesses can be varied in dimension along a row's length or from row to row, or both, in the embodiment illustrated in FIGS. 19 and 20 the projections and recesses have a common configuration across the entire pattern 202P. Further, while there is featured common diameter profile rings across the width of the tooling roller (e.g., profile rings as in profile rings 700 and 702), there can also be provided varying height profile rings (e.g., different height sets) across the width to further vary the output products (e.g., the aforementioned higher and lower projection extensions for the square pattern projections and wavy pattern respectively), or there can be variations in profile roller contact diameters relative to opposing tooling rollers or the like. For example, rather than having a pair of opposing equal diameter roller tooling devices, such as a pair of tooling devices 202 arranged in an opposite projection/valley relative orientation, an opposite compression roller of a set can be in a different respective diameter arrangement (as in a larger/smaller respective diameter correspondence arrangement).

Also, with reference to pattern 202P and tool device 202 in FIGS. 19 and 20 there is featured in the pattern a plurality of columns in the output product, with the pattern illustrating 14 columns as a non-limiting example of the number of projections provided on die roller with those projections' columns referenced as C1, C2, C3 CL for the 360° wrap schematically represented by pattern 202P. The number of columns represented in pattern 202P can either represent the total length of the output product (e.g., one rotation for final length of output product), be less than (slab contact over less than a full rotation of tool device 202), or the output project can be longer than the circumferential length of the roller as by repeating, at least partially, a prior rotation's pattern application relative to a slab of material being profiled relative to, for example, a rolled out strip of compressible slab material.

FIGS. 19A, 19B and 20 show closer views of projections 212 with FIG. 19A providing a cut-away, cross-sectional view taken along cross-section line X-X of pattern 202P of FIG. 20. FIG. 19B provides a top plan view of the rim configuration presented in cross section in FIG. 19A. FIG. 21 provides a cross-sectional view taken through an illustrative profile ring as an example of a tool device 202. The cross-sectional and plan views of post 202 shown in FIGS. 19A, 19B and 21 can be considered a universal illustration in the FIG. 19 embodiment of tool device 202 as each of the posts shown in the FIG. 20 embodiment are shown with a common configuration. In view of the symmetrical relationship for projections 212, a cross-sectional view directed perpendicular to cross-section line X-X, presents a similar presentation (at least for the upper portion of the projections) of the generally “concave square” profile of that projection.

FIG. 19B shows a top plan view of the top portion of projection 212 which features an upper extremity material contact ring or rim 276 which is shown as continuous or uninterrupted in this embodiment such that contact ring 276 extends about the entire periphery of the upper body portion 278 supporting the contact ring 276. Further, in the illustrated embodiment, contact rim 276 has a common outer wall 280 which is shown extending in continuous or in uninterrupted fashion from an uppermost edge 277 down to the body portion 278 which, in turn, extends continuously to a contact point with the exterior surface 210 of the base body 204 which defines the various valley floor surfaces such as the circular configured valley floors 213 shown in the pattern view of FIG. 20 (e.g., a curved fillet wall border therewith or a sharp edge border connection as shown for the circumferential extension cross-section). Also, in alternate embodiments the surrounding (material reception) rim or ring can have discontinuities as in periodic gaps or breaks, although with the preference for efficient material capture in the recessed region at the distal end of the projections, a continuous peripheral rim is preferred in many use settings.

In the illustrated embodiment, outer wall 280 of contact ring 276 comprises a set of wall sections 280A, 280B, 280C and 280D, which, in this embodiment, are equal in length from the respective first edge point to a second edge point (the center of the curved corner edging with the edge points represented by the four representative points P1 to P4 in FIG. 19B spaced by a distance (Lc or Lp)). As seen, straight line extensions between respective points P1 to P4 presents a square cross-section with the actual curved contoured side walls extending between those same respective points presenting a “square concave” configuration. Further, the curved respective walls 280A to 280D are shown extending in a collapsing curved, concave profile fashion with each having a common radius of curvature represented by Rc (e.g., a radius curvature value of 3.4 inches, for example).

Ring or rim 276 is further illustrated in FIGS. 19A and 19B as having interior wall 281 (with interior wall sections 281A to 281D) which also preferably extends in continuous fashion and in the illustrated embodiment is shown as having a generally corresponding curved configuration as the corresponding upper portion of outer wall 280. Also, interior wall 281 extends into the interior floor space 285 in the vertical direction while bowing along its length in a concave fashion to accommodate the concave configuration of the outer wall sections 280A to 280D while maintaining a generally common thickness along its length. Alternate embodiments of the invention feature non-corresponding arrangements between inner and outer wall surfaces. As shown, ring 276 has an uppermost (exposed) rim surface 286 extending between the uppermost portion of interior wall 281 and the uppermost portion of outer wall 280 (with thickness Trc shown in FIG. 19B).

Also, body portion 278 has projection floor recess 285 which presents a projection recess floor stepped down from the rim 276 which is defined by interior wall section 281 (e.g., the projection recess floor 285 is at, and radially internal, of the outer periphery of rim 286 such that it borders, at its peripheral extremity, with interior wall sections 281A to 281D). The interior wall sections 281A to 281D of ring 276 and the exposed interior floor surface 285 thus define a material receiving cavity 288 (preferably a generally fully filled material receiving cavity upon sufficient compression relative to the material being convoluted) at the upper extremity of each projection 212. The step down projection recess floor 285 can also be varied to suit the desired output product characteristics with there being illustrated in schematic (dash line) a deeper step down distance as shown by the floor 285′ depiction. The step down can also be lessened in height to be shallower than that shown in FIG. 19A (not shown). Rim surface 286 also represents in the embodiment illustrated a material first contact surface of post 212.

As shown in FIGS. 19A and 19B some of the dimensions of the top portion of projection 202 include rim height Hcr from the projection recess floor 285 to the uppermost rim edge 277 and projection height Hcp (from the valley floor 213 to the edge 277). Also, the cross-sectional thickness of ring 276 is referenced as Trc, with all four ring segments preferably having a common thickness in this embodiment, although alternate embodiments include ring segments of different thickness about the ring periphery. While not intending to be limiting some suitable dimensions for Hcr, Hcp and Trc include 0.1 to 0.3 inch, 0.2 to 1.0 inch and 0.05 to 0.2 inch respectively; or more preferably 0.15 to 0.2 inch, 0.3 to 0.7 inch and 0.075 to 0.125 inch respectively with values of 0.188, 0.5 and 0.1 inch, respectively, being further illustrative of a non-limiting, exemplary embodiment of the invention.

The concave curvatures presented by each of the projections exterior walls 280A to 280D also result in circular shaped valley floors being formed external to the projections such as the earlier noted valley floors 215A, 215B, etc., which, as seen by FIG. 20, include circular profiles interdispersed between the concave square shaped projections. These circular floor sections preferably have a radius Rfs (with Rfs preferably equal to Rc of the concave side walls 280) of 3 to 5 inches with a radius of about 3.5 inches being illustrative of an exemplary embodiment.

As further seen in the projection profiles like that shown in FIGS. 19A, 19B and 21, there is a sequence along the circumferential (and, for this illustrated embodiment, as well along the longitudinal (e.g., along the axis of rotation extension) length of the profile ring or sleeve such as that represented in FIG. 19) of a tooling valley recess floor/a step up to the top of a projection protrusion's rim/a step-down to a projection recess exposed floor surrounded by a rim extension of the projection, a step-up to the top of a rim section on an opposing side (inclusive of circular shaped or the like opposite diameter) of the same projection (preferably a portion of a same, continuous rim), and then a step down to another valley floor of the base body of the tooling device. In an exemplary embodiment the step down from the first rim section's top edge 286 to the projection recess floor 285 is less than the distance from the floor 285 to the valley floor 213 defined by exposed surface 210. In other words, for this embodiment, Hcr is less than (Hcp-Hcr), although in alternate embodiments Hcr is made equal to or more than (Hcp-Hcr) with an example of the latter seen in the valley floor 285′ shown in dashed lines in FIG. 19A as an alternate embodiment. For example, an exemplary embodiment features about a 35%+/−5% step down to projection recess floor 285 while the dash line step down at 285′ features about a 75%+/−5% step down relative to the overall projection height. Thus, an example of a step down value is 0.2+/−0.012 inch, as with a 0.188 inch step down for one projection height (e.g., 0.5 inch) which provides a lower percentage step down as compared to that same step down value for a lower height projection (e.g., a 0.25 inch height projection). As further examples, a ratio value for Hcr/Hcp (which is representative of the noted step downs) of 1:4 to 4:5 is featured in embodiments of the present invention. Also, the projection recess floor 285 preferably represents a generally planar surface as in one that is arranged perpendicular to the rim interior wall 281, although a curved (conforming to profile ring curvature) or sloped section(s) or additional sub-recesses in the exposed projection recess floor within the confines of the interior wall 281 are also featured as alternate embodiments (as with the other embodiments described herein). Again, a configuration that provides a good capture retention of material is desired to facilitate providing for a flat topped output.

FIG. 19B further illustrates the length dimensions (e.g., the circumferential direction extension as in along the length extension of the footprint track of FIG. 20 and a tool width extension perpendicular thereto) as Lc and Lp, with some non limiting values suited for dimensions Lc and Lp including 0.75 to 5 inches, as in 1.0 to 2.0 inches, with a value of 1.5+/−0.2 inches being illustrative of one embodiment of the invention. In this embodiment, with a concave square presentation, the length perpendicular to length Lc extension (length Lp) is equal in value to Lc, with Lp extending along the direction of axial extension of tool device. As an example of an additional embodiment of the present invention, a rectangular arrangement is presented with Lp not equal to Lc with either Lp or Lc being larger. In addition, FIG. 20 shows the width spacing between projections as BW2 which in an exemplary embodiment is greater than width length Lp of the projections as in a 10-50% (e.g., 12.5%) greater value in BW2 compared to Lp (e.g., 1.63 in for Lp and 1.8 inch for BW2 as a non-limiting example). Further, the profile ring width BW1 preferably ranges from 3 inches to 18 inches as in about a 10.3 inch width length for BW1. Also, in the FIG. 20 pattern there preferably exists the same distance and spacing characteristics for Lc as described above for Lp. Further, a suitable profile ring diameter value set for BD1, BD2 and BD3 includes, for example, 4.7 inch, 6.7 inch and 7.7 inch.

Also, with reference to FIG. 19B, for example, there is seen that the relative area occupied by the rim's area Ar is preferably less than 50% of the overall area represented by the outer wall 280 at the upper extremity of rim 276 inward (Ap). An illustrative ratio Ar/Ap value range for projection 212 (as well as other embodiments under the present inventive subject matter) is, for example, 3-20% as in 5-12% with a ratio value for Ar/Ap of 8+/−3% being illustrative of a ratio for the square cross-section view shown in the FIG. 20 pattern (which provides a rim surface area of about 0.15 in²±0.05 in²).

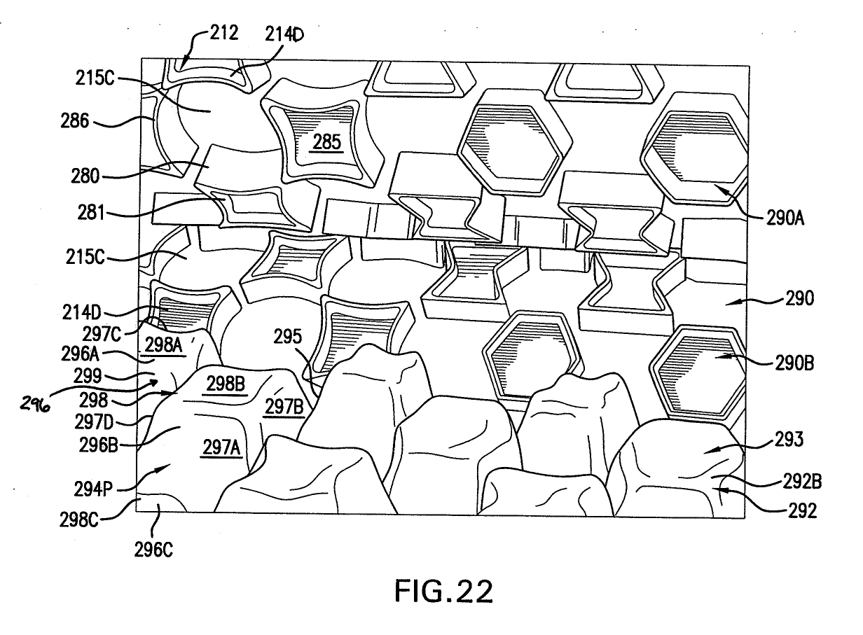

FIG. 22 shows a partial view of tooling device assembly 290 shown in the illustrated formed of a set of compression rollers (e.g., an upper compression roller 290A in a tooling set with compression roller 290B) as well as a section of the exposed surface 293 of output product 292 (e.g., a section of one of two (or more) output products generated by the tooling set of rollers following cutting or splitting, with a lower output product 292B illustrated in FIG. 22). Tooling device assembly 290 features a hybrid tooling device set (290A, 290B) with each of the rollers in the set having different pattern profile rings with the left side featuring a convex square tool device portion and the right side a “hexagonal-hourglass” pattern (described in greater detail below). Thus, with an opposing set of tooling set rollers for this “convex square” pattern a projection having the configuration seen in FIGS. 19A and 19B extends into the circular valley (such as 213) of the opposing roller with the resultant output product being exemplified by the below described output products 292B. The cut output product 292B results in surface pattern 294P in exposed surface 293 of that section of the output product being visible. As seen in FIG. 22, the rollers 290A and 290B have a post pattern and post configuration similar to that shown in FIG. 20 such that a “concave square flat top pattern” 294P is generated in the output product (with preferably a similar “mirror image” or one projection offset pattern being generated in the corresponding mirror image output product which is not shown for improved viewing of the exposed surface of output product 292 (the lower of two output product 292B).

FIG. 22 further illustrates tooling projections such as 212 with the above described outer wall 280, inner wall 281, rim surface 286 and exposed projection recessed floor 285 in tooling 290A (e.g., an upper tooling device in a set of two). Also, the compressible body output product 292 is, for example, a foam body as in a polyurethane foam body, that has pad body protuberances 296 partially defining a portion of the exposed surface 293 of output product 292B (e.g., a convoluted surface in a foam pad). Further representing the exposed surface 293 are valley surfaces 295, which together with the exposed side walls 297A to 297D of protuberances 296, define the recesses or valleys 299 formed between sets of protuberances 296 (e.g., the cavity or valley 299 can be considered defined on the top by an above positioned horizontal plane lying flush on the top surface of a protuberance 296 (representing a generally flat top surface) and the respective valley surfaces 295 below as well as a side wall represented by an extension incorporating the exposed side walls 297A to 297D. Protuberances 296 (e.g., 296A, 296B, 296C . . . etc) each have a relatively flat upper protuberance surface 298 (e.g., a body contact surface). Also, for the illustrated embodiment of FIG. 22, each of flat upper protuberance surfaces (e.g., 298A, 298B, 298C, etc.) are shown as individually having generally a common plane, flat presentation surface and all are shown in this embodiment as presenting a generally common plane within a common projection configuration zone (e.g., a horizontal plane lies generally flush on each of the protuberances 298 in the embodiment shown), although alternate embodiments, which feature different level protuberances in the same output product, are featured as well (e.g., a plurality of different height protuberances falling or dispersed within a common zone of the output product or different height protuberances in respective independent zones in a common, multi-zone output product).

Thus, upon performing a profiling operation with profiler means such as that described above featuring counter rotating profiler compression tooling rollers, the compressible material (e.g., foam) that is forced to a greater extent by a projection of the lower roller into the cavity of an upper roller at the level of compression present upon cutting will result in a deeper cavity being formed in the lower output product. Conversely, the deeper the cavity formed in the lower output product of this embodiment, the greater the extension of the corresponding protrusion of the upper output product as more material is forced into the upper roller's cavity by the opposing, lower roller protrusion. This leads to more material available upon a return to a relaxed state and thus a greater level of protrusion extension in that upper output product. The presence of a projection reception recess in the projections also acts to lessen the interior extension potential for the upper output product's protrusion (as less material is compressed into the upper roller's cavity by the lower roller's projection or the compression level is less in the interior versus the exterior for that predetermined projection recess floor area). Under embodiments of the invention, the projection recess floor positioning facilitates the formation of generally “flat tops” in those protrusions (e.g., flat tops having the characteristics such as those described above for the other embodiments including the potential presence of, for example, a concavity in the exposed uppermost surface of the projection surrounded by an uppermost rim region of the compressible material).

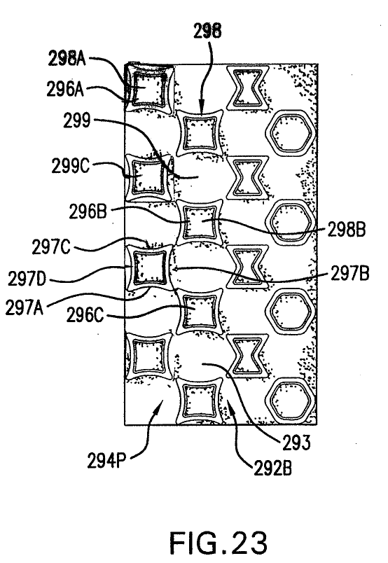

FIG. 23 shows a top plan view of a section of output product 292B where there can be seen surface pattern 294P comprising square concave projections 296 with essentially flat top surfaces 298. Further shown is valley floor spacing 295 defining valleys between the side walls 297A, 297B, 297C and 297D of protrusions 296.

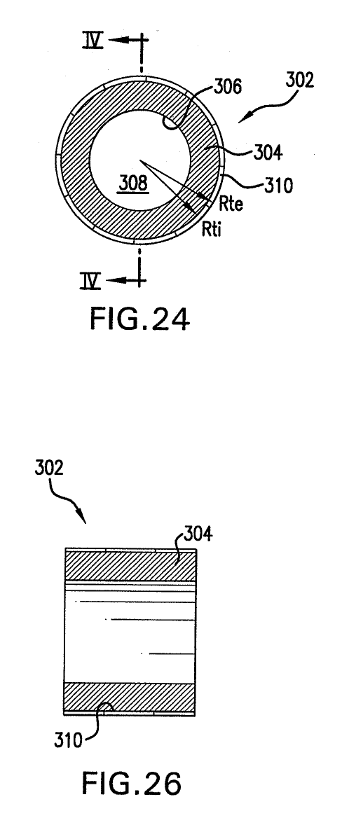

FIG. 24 illustrates an end view of an alternate tool embodiment 302 of the invention (referenced as a “nested hexagonal” tool device for convenience below). As seen from FIG. 24 tool device 302 includes base body 304 having an interior surface 306 defining central cavity 308 in similar fashion as in the earlier “profile ring” embodiments and related tooling means

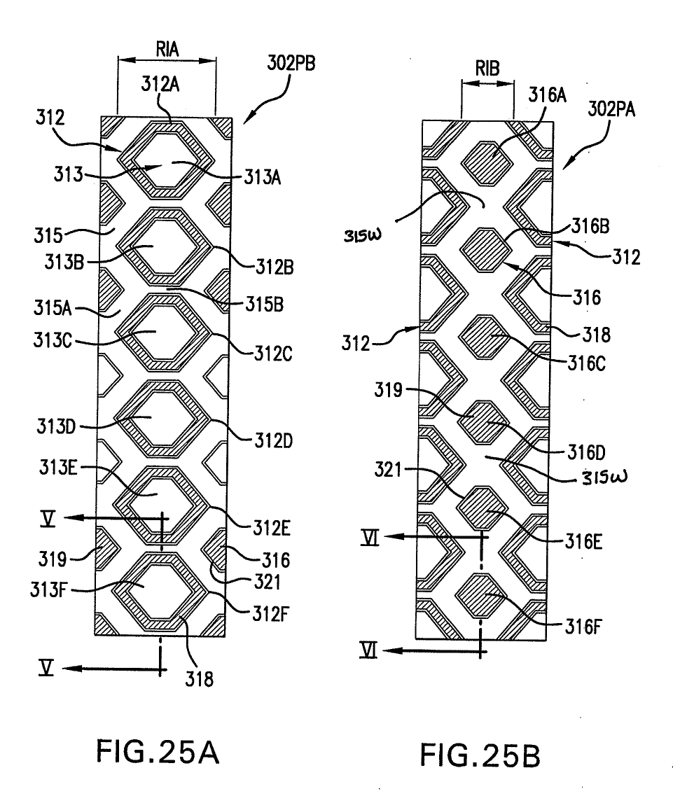

FIGS. 25A and 25B show respective footprint patterns 302PA and 302PB of the tool embodiment shown in FIG. 24. As seen from FIGS. 25A and 25B as well as FIGS. 26-28, extending off (e.g., radially outward) from exterior surface 310 of tool device 302 are a plurality of annular projections 312 (e.g., 312A, 312B, 312C, 312D, 312E and 312F shown arranged in row R1A in FIG. 25A of pattern 302PA). In this illustrated embodiment, the annular projections 312 have hexagonal configurations (it is also shown in the footprints shown in FIGS. 25A and 25B that some of the pattern projections 312 and 316 have partial configurations (e.g., partial annular configuration) which can be completed upon mating with a stacked additional profile ring or, as an additional example, represent a partial protrusion output product side edge formation tool device depending on positioning). There is also featured a plurality of internal valley floors 313 (e.g., 313A, 313B, 313C, 313D, 313E, 313F, of row R1A) positioned within the interior region of annular projections 312 and having a common floor surface with the exposed exterior surface 310 of base body 304. There is further provided external valley floor regions 315 which extend about the exterior surface of annular projections 312, and which valley floors also represent different sections of the exterior, exposed surface 310. The individual projections 312 are shown as being circumferentially spaced apart in their extension about the illustrated cylindrical tool device 302. There is wider valley floor regions 315W extending about the interior projections 316 as compared to the smaller clearance spaces in valley floor regions 315 formed between projections 312 along the circumferential.

FIG. 25B further illustrates (as a second, different type set of projections) internal projections 316 (e.g., 316A, 316B, 316C, 316D, 316E, 316F) which are shown only in partial section in footprint 302PB. As shown in footprint 302PA a plurality of projections 316 are arranged in equally spaced apart fashion along row R1B of pattern 302P. The internal projections 316 are shown as having a common exterior configuration and alignment orientation as that of the interior surface of annular projections 312 (e.g., hexagonal) and are shown to have an outer periphery that is smaller than that of the interior surface of projections 312. Thus, during profiling the interior projections 316 are aligned as to provide for a “nested” hexagonal arrangement wherein a central axis of radial extension of an interior projection 316 coincides with a central axis of the annular, exterior projection 312 and the interior projection has a smaller area footprint such that the interior projections 316 can extend within the interior confines of the annular projections 312 if brought into an overlapping nesting fashion (which during convolution such an overlapping nesting arrangement may or may not occur depending on the pre-set, desired, tooling settings and material(s) involved—such that “nesting” is in reference to compression of material into an interrelationship based on the interior and exterior projections' radial positioning and not necessarily that there exists circumferential tooling radial overlap). Thus, “nesting” arrangements can exist despite there being radial spacing (upon maximum compression) between the exposed uppermost surfaces of the aligned interior and exterior projections (312 and 316).

Moreover, as with the first embodiment of FIG. 7, the annular hexagonally shaped interior projections 312 of tool device 302 are shown arranged circumferentially in equal spaced sequence along their respective rows. Interior projections 316 are also shown as being equally spaced about the length of the footprint (or circumferentially relative to the tool device 302). Also, a corresponding “nesting” arrangement takes place relative to matching partial hexagonal interior and exterior projections such as those that may be found on the outer extremities of the tooling.

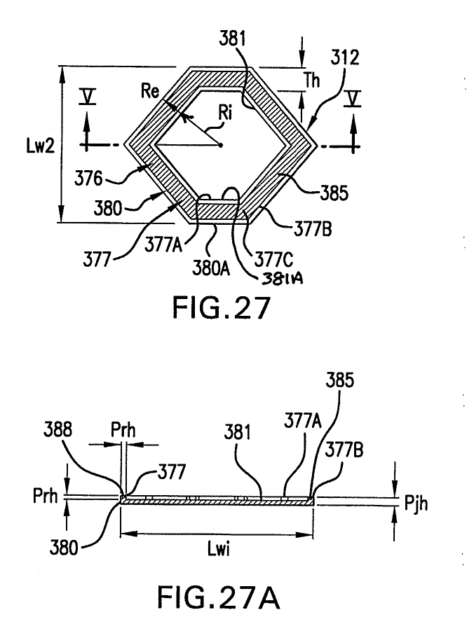

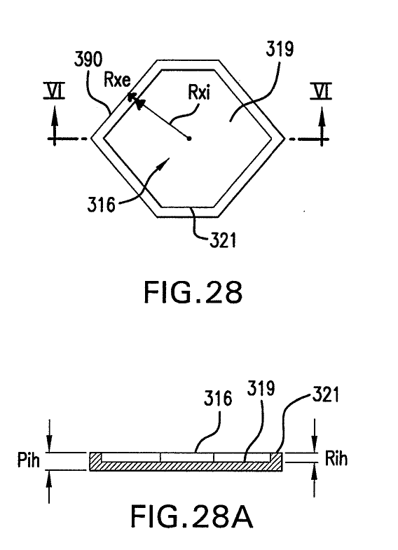

Further, as seen in FIGS. 27 and 27A, the annular hexagonally shaped exterior projections 312 are formed with a step down projection recess floor 318 defined by a pair of annular rim rings positioned at the projections' radially exposed outer ends, while the interior projections 316 are shown as having interior projection recessed floor region 319 bordered by a hexagonal shaped single wall rim extension 321. Rim extension 321 and the interior recessed floor region 319 are shown in more detail in FIGS. 28 and 28A wherein there can be seen a similar step down depth for floor region 319 as that for the annular channels 318 of projections 312 and 316. The possible projection characteristics (e.g., relative floor height, rim height and overall projection height, etc.) is similar to that which was described in the earlier embodiments and the step-down depth can be the same for each of floor regions 319 and 318 (either relative to each other generally and/or within a common group).

Depending on the desired width of the output product, there can be provided multiple number of rows on a set of tool devices that have respective patterns 302PA and 302PB each arranged on a single integrated tooling device suited for the width(s) of the input slab. As another example, the tooling device can comprise a unitary cylinder or a tooling device based on a plurality of stacked tool devices having a corresponding pattern as that represented in respective patterns 302PA and 302PB (e.g., the tool device 302 can either be already of the desired width in and of itself (in which case the footprints 302A and 302B illustrate only a partial footprint view) or there can be a plurality of “tool devices” stacked on a shaft or the like to produce tooling having the desired overall width in the output product with the pattern being an illustrative example of possible profile ring tooling patterns.

As further seen in FIGS. 25A and 25B, each row preferably has a multitude of individual projection/space combinations as in the illustrated row R1A recess-projection-recess sequence, with the number of projections and recesses shown for this embodiment being the same in each row (e.g., 4 to 20 with 6 projections being shown in the embodiment illustrated as an example). A difference present in the projections 312 as compared to earlier projection embodiments includes the feature that the annular projection encircles a valley floor space (e.g., portion 313 of exposed surface 310) in addition to being surrounded by valley spacing.

FIGS. 27 and 27A show closer views of annular projections 312 with FIG. 27A providing a cut-away, cross-sectional view taken along cross-section line V-V of projection 312 of FIG. 27. FIG. 27 provides a top plan view of the rim configuration which is presented in cross section in FIG. 27A.

As seen from FIGS. 27 and 27A, the annular projection 312 in this embodiment has an exterior, hexagonal shaped projection wall 380 (comprising six segments with one of the six identified as 380A) and an interior wall 381 (also with six segments with one of the six segments identified as 381A) which together define the interior and exterior surfaces of projection ring 376, which projection ring or rim 376 features an upper extremity material contact surface 377. The contact surface 377 of rim 376 is further shown in this embodiment as being continuous or uninterrupted such that contact surface 377 extends about the entire periphery of the upper body portion of ring 376. Also, contact surface 377 is made up of opposing rim extensions 377A and 377B which extend to opposite sides of interior (step down) projection recess floor 385 which defines a projection recess channel 377C that is also of an annular hexagonal configuration.

FIG. 27 further shows the relative thickness Th for the annular ring 376 as the difference between radial lines Re and Ri, with Re extending from the center of the annular ring out to the outer wall 380 in a transverse orientation and a commonly extending radial line Ri extending to the interior wall surface 381. Also, it is preferable to the have the difference of (Re-Ri) less than the value of Ri (e.g., the width of the annular channel relative to a transverse line through the annular ring being made less than the distance along that transverse line from the interior wall 381 to a central axis of the annular ring, although variations are also featured under the present invention as in having that difference equal to Ri and also the difference being larger than Ri (e.g., a wider annular projection recess channel as compared to the projection recess floor radial length Ri)).

FIGS. 24, 26, 27A and 28A also show the relative radial extension of the projections 312 and 316 off from the exposed valley floor (corresponding with the exposed surface 310 of the base body) by way of the difference between the radius line Rte (FIG. 24) extending to the outermost edge of the projection and the radius line Rti extending to the exposed circumferential surface 310 of the base body 304. Thus, in this embodiment the relative distance that projections 312 and 316 extend from the valley floor is the same although in alternate embodiments one or the other is made larger (e.g., within a 25% differential). The projection height Pjh for the annular projection 312, (as well as projection height Pih for projections 316) is represented by the difference between Rte-Rti. FIG. 27A further shows the projection rim height Prh with the difference between Pjh and Prh representing the height level at which floor surface 385 of the annular projection recess channel 377C extends above the valley floor surface of exposed surface 310. The aforementioned ratios and height and distance values for the square cross-section (as well as the other embodiments) is illustrative of the levels contemplated for the projection recess floor 385 and corresponding rim extension therefrom to define the depth of the step down to the projection recess floor or annular channel into which the compressible material is compressed when the interior and exterior projections come into a “nesting” relationship. However, in this illustrated embodiment there is preferably presented a lower level range of projection height and a relatively low level height step down. For example, a 0.15 to 0.5 inch projection height as in about 0.188 inch projection height together with a step down of 0.075 to 0.3 inches as in a 0.1 inch step down height (e.g., a ratio of step down height to projection recess floor height above valley surface of around 50%±10% (for each of projection types 312 and 316 in the illustrated embodiment)).

As further seen in the projection profiles like that shown in FIG. 27A, there is a sequence along the circumferential (and, for this illustrated embodiment, as well along the longitudinal length (e.g., axis of rotation extension) of the tool device (e.g., a profile ring or sleeve) of (i) a tooling valley exterior recess floor (ii) a step up to the top of a projection's rim (iii) a step-down to a projection recess exposed floor forming part of an annular channel (iv) a step-up to the top of a rim section on an opposing side of the channel defining opposite rim section of the annular ring, and (v) then a step down to an interior valley floor of the tooling device, (vi) a step up to the top of a different section of the projection's rim spaced across from the interior valley floor (vii) a step-down to a different section of the projection recess exposed floor forming part of the annular channel, (viii) a step-up to the top of a rim section opposing the last mentioned rim section, and (ix) then a step down to another portion of the exterior valley floor of the tool device.

Further, in this embodiment the profile tool widths RIA and RIB also preferably fall within lower portions of the above-described ranges as in a value of about 6 inches for each. Also, the relative diameters for the clearance space 308, exposed valley floor surface 310 (2 times Rti) and outermost circumferential extremity of the tool device (2 times Rte) is preferably generally within the ranges of the above-described embodiments such as an outer extremity diameter of 7.66 inches and an exposed body surface diameter of 7.29 inches and an interior diameter of 4.72 inches as some non-limiting examples.

FIGS. 27 and 27A also illustrate the length dimensions including the maximum width Lwi that coincides with the cross-section line V-V in FIG. 27 with non limiting values suited for such a dimension being 2 inches to 6 inches, more preferably 3 inches to 5 inches with a value of 4 inches being illustrative of one embodiment of the invention. In this embodiment with a hexagonal presentation the length perpendicular to length Lwi is represented by length Lw2 which is shown less in value to Lwi for this embodiment.

Further, with reference to FIGS. 28 and 28A there is seen interior projection 316 in plan view and in cross-section. As seen from FIG. 28, the radial line Rxe, preferably has a value less than Ri with a spacing range between the exterior wall 390 and an adjacent most section of interior wall 381 of a corresponding projection 312 being sufficient to achieve a compressible material “nesting” projection arrangement with the interior projection 316 representing more than a majority of the area represented by the area of the projection recess floor 385. Also, the difference between radius line Rxe and Rxi in FIG. 28 is representative of the thickness of the annular rim that steps down to valley floor 319.

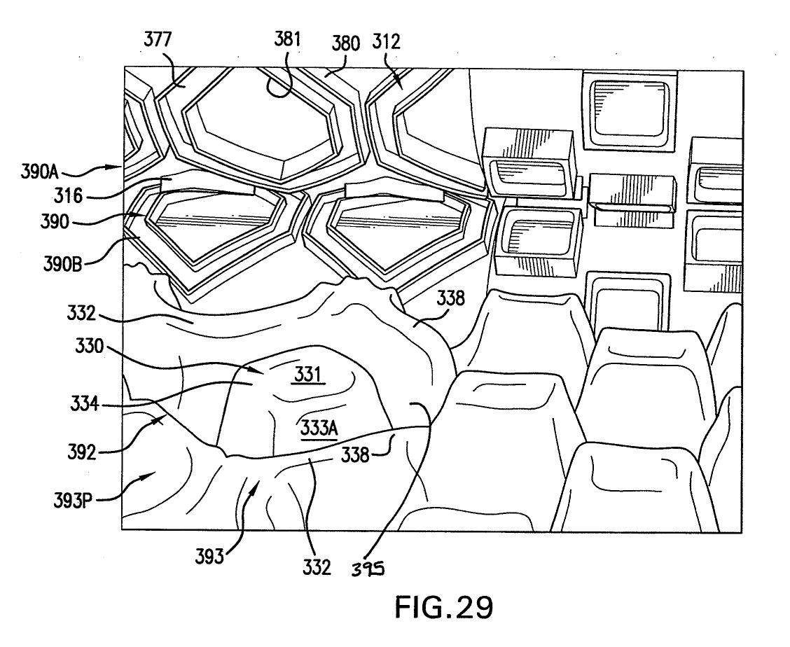

FIG. 29 shows a partial view of tooling device assembly 390 shown in the illustrated form of a hybrid pattern compression roller (e.g., an upper compression roller in a tooling set of compression rollers having a left side portion featuring the “nested hexagonal” pattern discussed immediately above and the “square” pattern discussed for the first embodiment to the right thereof). Further shown in FIG. 29 is a section of the exposed surface 393 of output product 392 (e.g., a section of one of two (or more) output products generated by the tooling set of rollers following cutting or splitting). Thus, with an opposing set of rollers having the above-described tool patterns 302PA and 302PB there is provided a “nested hexagonal” profiling pattern comprising an interior hexagonal shaped tool projection 316 that is brought to extend toward the interior floor region 313 of an opposing hexagonal annular ring of projection 312 while at the same time the annular ring extends toward a valley region extending about the interior projection 312 (such as valley surface 315) of the opposing roller with the resultant output products being exemplified by the below described output product 392. The cutting then results in surface pattern 393P in exposed surface 393 of that section of the output product being visible. As seen in FIG. 29, the tool devices 390 (390A and 390B) results in an output product having a nested hexagonal configuration featuring hexagonal cross-sectioned central hexagonal post protrusions 330 surrounded by a foam protrusion rim complex which in the illustrated embodiment features a honeycomb like continuous protrusion rim complex 332. The central post protrusions 330 are further shown in FIG. 29 as having a flat top surface as in an essentially flat exposed uppermost surface 331 and six sides with one of the six represented by side wall 333A. For example a generally flat exposed uppermost surface includes a “no bulbous” or no convex hill top like extension, but is also inclusive of a flat or an essentially flat surface such as an essentially flat surface that comprises a relatively slight concavity extending down into the protrusion as in one that forms a compressible material peripheral ridge such as represented by surface 334 in FIG. 29 with essentially flat being inclusive of the above described levels of concavity deviation in the exposed region of a protrusion.

FIG. 29 further illustrates protrusion rim complex 332 as extending around the interior positioned central hexagonal post protrusions 330 and with the ridge complex 332 shown as being in an interconnected (e.g., hexagonal) configured, honeycomb like arrangement relative to a plurality of internal, central hexagonal protrusions such as 330. Ridge extension 332 is also shown as having an upper exposed surface 338 which is also shown to be a generally flat top surface (as in an essentially flat top surface which, as described above, is inclusive of a slight convex dip along the upper surface of the ridge complex). Also, the compressible body output product 392 can be of a variety of materials as in a foam body (e.g., as in a polyurethane foam body).

FIG. 29 further shows the output product 392 having surface pattern 393P inclusive of the above-described protuberances 330 and 332 with an adjacent output product valley flooring 395 extending therebetween and around the interior protrusion in island like fashion.

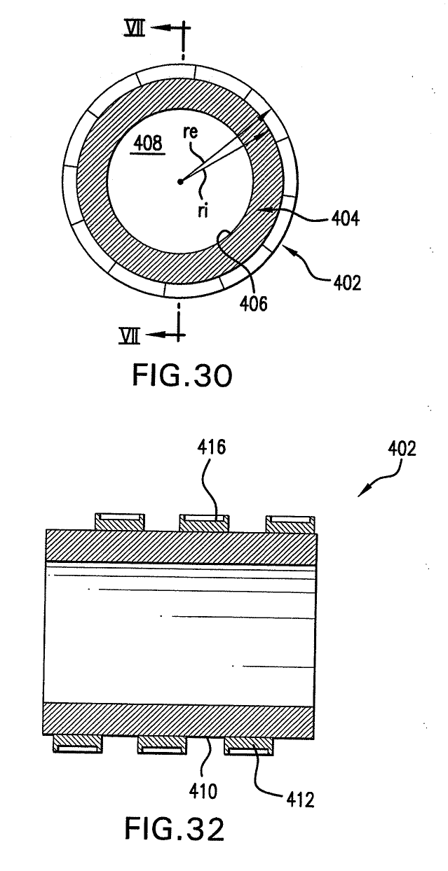

FIG. 30 illustrates an end view of an alternate tool device embodiment 402 or tool means of the invention (referenced as “hexagonal-hourglass” tooling for convenience below). As seen from FIG. 30 tool device 402 includes base body 404 having an interior surface 406 defining central cavity 408 in similar fashion as in the earlier “profile ring” embodiments and related tooling means described above. FIG. 30 also shows interior radius line “ri” extending to the exterior surface of base body 404 defining the valley floor surface between projections as well as with an exterior radius line “re” extending from the rotation central axis to the outermost circumferential surface of tool device 402. A similar radius or diameter interrelationship exists as in the other embodiments with a projection height such as those described for the concave square embodiment being illustrative (e.g., a 0.5 inch height projection level with a 0.188 inch step down and with an exterior diameter of 7.66 (2xre) and an exposed valley surface diameter of 6.66 (2xri) being illustrative but not intended as being limiting).

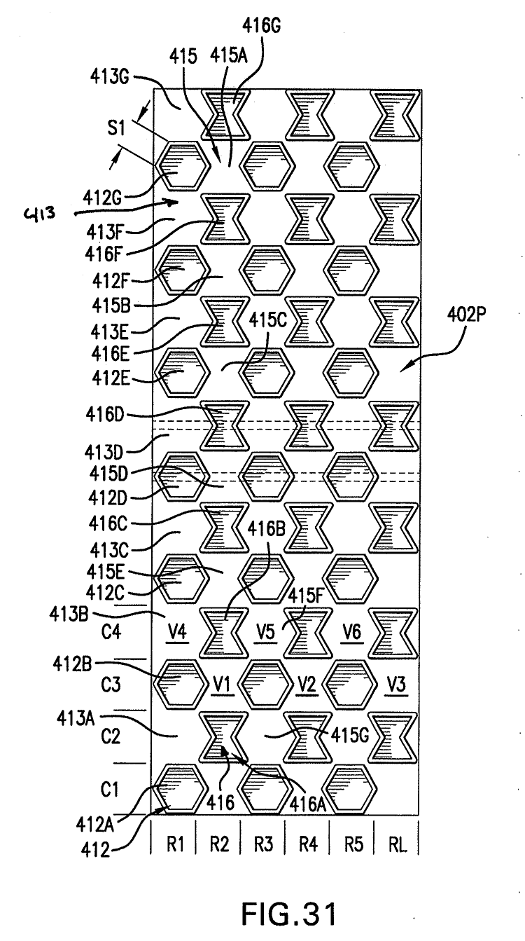

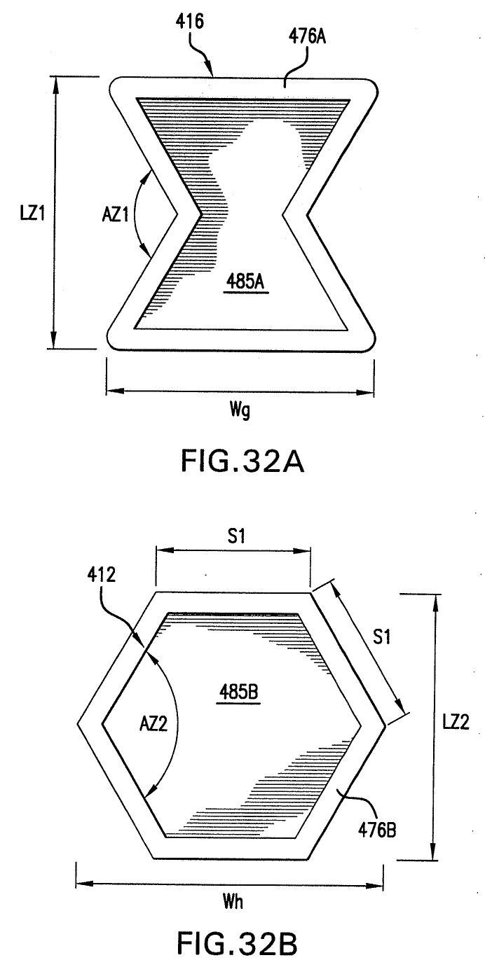

FIG. 31 shows footprint pattern 402P of the tool embodiment shown in FIG. 30. As seen from FIGS. 30 to 32, extending off (e.g., radially outward) from exterior surface 410 of tool device 402 are a plurality of first type configured projections (in the illustrated embodiment the first type are hexagonal rimmed projections) 412 (e.g., 412A, 412B, 412C, 412D, 412E, 412F and 412G shown arranged along row R1). There is also featured a plurality of internal valley floors 413 (e.g., 413A, 413B, 413C, 413D, 413E, 413F, 413G—of row R1), and which valley floors 413 represent different sections of the exterior, exposed surface 410. The individual projections 412 are shown as being circumferentially spaced apart in their extension about the illustrated cylindrical tool device 402. Further as seen from FIGS. 31 and 32B the hexagonal shaped projections are shown as having equal length exterior walls of length S1 (e.g., of a length 0.5 to 2 inches as in 0.9 inches).

As further shown by FIG. 31 there is featured a second set of different type projections 416 (e.g., 416A, 416B, 416C, 416D, 416E, 416F, 416G) arranged in spaced fashion along row R2. Projections 416 are shown as having a different exterior configuration as compared to the first type projections 412, which in the illustrated embodiment involves “hourglass” rimmed configured projections in every other row with adjacent or intermediate rows containing the first type (e.g., hexagonal) rimmed projections.

The projections of a first of the two types, however, preferably have corresponding shaped receiving recesses in an opposite tooling device as is the situation for the second type of projections. For example, as seen, the external wall configuration of the first type of rimmed projection results in clearance valley spaces along a common row (e.g., V1, V2, V3 along column C3 of the noted set of columns C1, C2, C3, etc.) designed to have a shape that generally conforms to the opposing projection of the other tool device (e.g., an hourglass valley floor configuration at V1 designed to receive a projection of an opposing roller similar to configuration as, for example, the hourglass shaped projection 416). In addition, the valley spaces such as V4, V5 and V6 in column C4 between the hourglass shaped rim projections also define cavities having a similar configuration to the projection shape of the first type (e.g., hexagonal shaped valley floors at V4, V5 and V6 designed to receive (direct overlap or forced material shaping radial push out) hexagonal rim shaped projections 412 of an opposing roller. Thus, during profiling, the interior projections 416 are aligned as to present a rimmed projection of a shape that corresponds with the shape of the receiving valley of an opposing roller in the area of a compressible material reception gap formed therebetween. A similar corresponding shaped valley and rimmed projection combination exists along the other rows as well.

Moreover, as with the first embodiment of FIG. 7, the interior projection sets 412 of tool device 402 are shown arranged circumferentially in equal spaced sequence along their respective rows. The second type of projections 416 are also shown as being equally spaced about the length of the footprint (or circumferentially relative to the tool device 402).

The hourglass shaped rimmed projections preferably have an obtuse side compression angle “AZ1” in FIG. 32A that corresponds to the exterior expansion surface side wall projection angle as represented by AZ2 in FIG. 32B with the angle of compression for the side walls resulting in the exterior side walls' vertex being set in preferably 25-50% of the overall width length Wg for projection 416 (e.g., a 33% compression) with corresponding expansion values in the hexagonal 412 projection's sidewalls. The length in the circumferential extension direction for each of the two different type projections is also shown in this embodiment to be about the same (e.g., Lz1≅Lz2) with examples being a range of 0.75 to 5 inches or 1 to 3 inches with 1.5+/−0.2 inches being a non-limiting value example. Also, a range of 0.5 of 2 inches for side wall S1 for the hexagonal shaped rimmed projections and more preferably 1.0 inch±0.2 is also illustrative of non-limiting examples. Also, the width extensions for the respective projections are also preferably similar (maximum and minimal) as in within 25% of each other. Examples include ranges similar to those presented above for the circumferential direction lengths. Also, tool device diameters are preferably similar to those described in the previous embodiments as in a 0.5 inch height projection. Examples of width length for Wh include 1.7±0.2 inches and for Wg of 1.5+/−0.2 (Wg is illustrative for the hourglass shaped rimmed projections 416 shown in FIG. 32A).

As further seen in FIGS. 32, 32A and 32B projections 412 (FIG. 32B) are formed with a correspondingly upper shaped rim extension 476B which steps down to the similarly configured (hexagonal shown) interior stepped projection recess floor 485B in similar fashion to the earlier embodiments. Also, projections 416 have an hourglass configured upper rim extension 476A which steps down to interior stepped similarly configured projection recess floor 485A in similar fashion to the earlier embodiments.

Depending on the desired width of the output product, there can be provided multiple number of rows on a unitary (e.g., a relatively wide cylindrical shaped tooling device) or the tooling device can comprise a plurality of stacked tool devices having a corresponding pattern similar or the same as that represented in 402P. The tool device width for pattern 402P is preferably within the above-described ranges for tool device widths with about a 9±0.5 inches range being illustrative for an exemplary embodiment. Also, each of the row R1 type circumferential areas preferably has similar percentage of projection occupation like those for the square and concave square embodiments.

The thickness of the rims (476A and 476B) for each of the projections 412 and 416 is preferably similar to that of the earlier embodiments described (e.g., 0.1 inch) and the step down depth of projection 412 relative to the step down depth of projections 416 is preferably equal or relatively similar (within 25%) or one can be made much deeper or shallower than the other such as within the above noted ranges of depth of projection recess floor relative to the depth of surrounding exposed surface of the base body described in the earlier embodiments. Similarly, the relative projection heights for projections is the same in exemplary hexagonal-hourglass pattern embodiments (e.g., each of 0.5 inch height) although alternate embodiments include making one of the two higher than the other or vice versa.

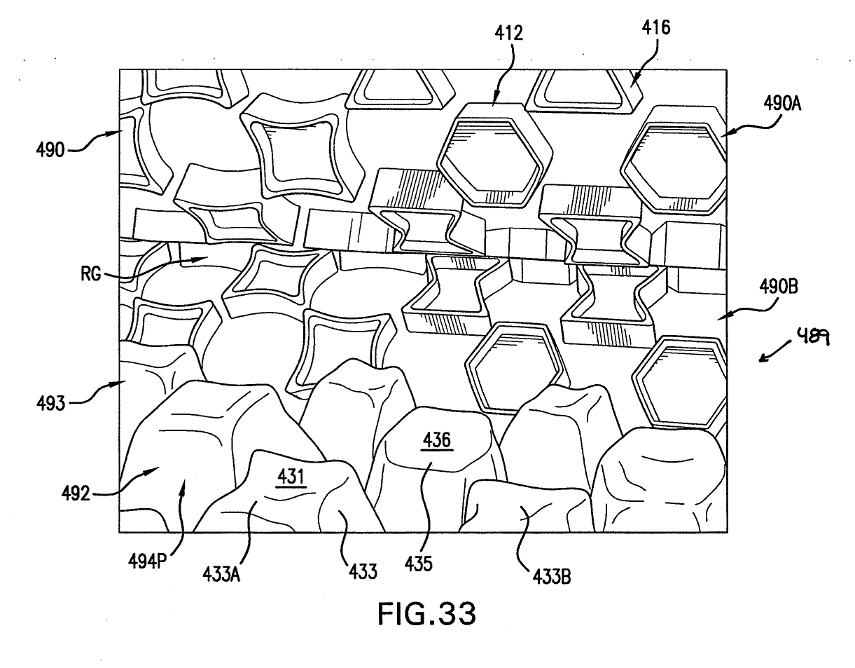

FIG. 33 shows a partial view of a profiler assembly 489 showing tooling device assembly 490, which in the illustrated form is shown comprising a compression profile roller set with a pair of offset tooling device rollers 490A and 490B with opposing “hexagonal-hourglass” rimmed projection patterns like that discussed immediately above shown to the right side and with a concave square tooling pattern shown to the left in each roller 490A and 490B. Further shown in FIG. 33 is a section of the exposed surface 493 of an output product 492 (e.g., a section of one of two (or more) output products generated by the tooling set of rollers following cutting). Thus, with an opposing set of rollers for this “hexagonal-hourglass” tool pattern a hexagonal shaped tool projection 412 of a first roller is brought to extend toward a similarly hexagonal shaped interior floor region (such as valley V4) of the second, opposing roller while the hourglass shaped rimmed projection 416 of the first roller is designed to align with a similarly shaped hourglass recess (such as valley V1) in the region of maximum compression within the reception gap RG and vice versa. Also, as seen from the pattern representation in FIG. 31 the side-to-side spacing between respective projections within a column is made sufficiently wide to accommodate the offset projection of an opposing roller. A similar relationship exists along respective rows from one projection to the next. However, the clearance gap between respective columns is made relatively small (e.g., less than 0.25 inches as in about 0.1 inch). Along the row extensions there is a degree of overlap with exterior edges of the hexagonal rims extending into the row zones of adjacent hourglass shaped projections as seen in FIG. 21.

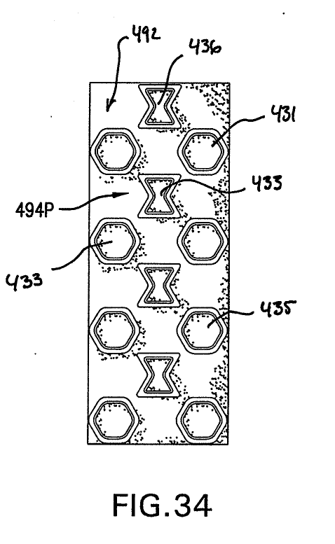

As seen from FIGS. 33 and 34 the cutting then results in surface pattern 494p in exposed surface 493 of that section of the output product. As seen in FIGS. 33 and 34, the tool devices 490A and 490B result in an output product 492 having both hexagonal and hourglass flat top protrusion sets formed over the exposed surface 493 of the output product with the hourglass shaped protrusions 433 shown being dispersed and positioned adjacent to hexagonal shaped protrusions 435 with both of the hexagonal and hourglass shaped protrusions presenting generally flat exposed uppermost surface 431 and 436, respectively (having similar flat top characteristics as in, for example, a slight concavity in the uppermost protrusion surface).

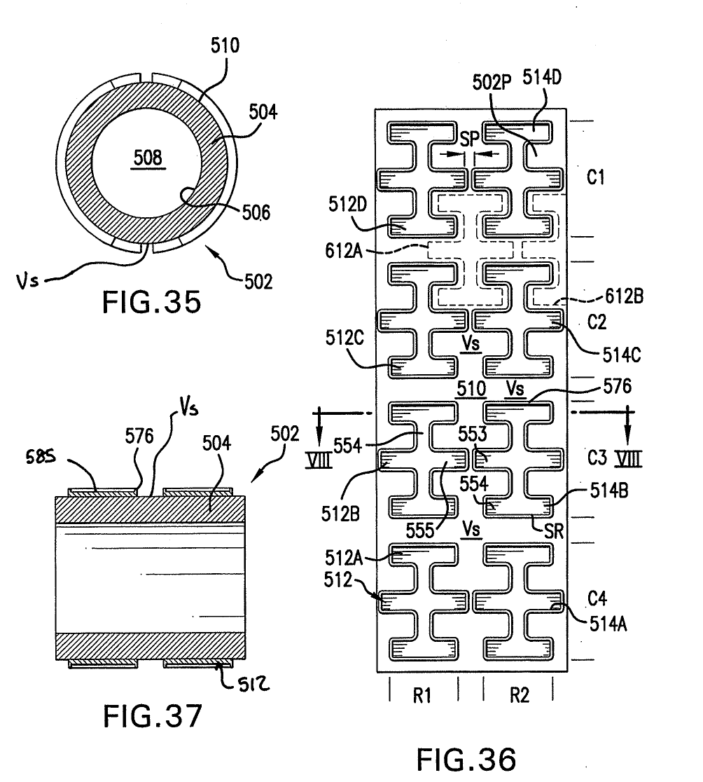

FIG. 35 illustrates an end view of an alternate tool device embodiment 502 or tool means of the invention (referenced as “modified I-beam” tooling for convenience below). As seen from FIG. 35 tool device 502 includes base body 504 having an interior surface 506 defining central cavity 508 in similar fashion as in the earlier “profile ring” embodiments and related tooling means. FIG. 35 further shows the exterior surface 510 of base body 504 which provides valley floor spacing Vs between or amongst the base of the modified I-beam projections 512 shown in FIG. 36.

FIG. 36 shows footprint patterns 502P of the tool embodiment shown in FIG. 35. As seen from FIGS. 35 to 37, extending off (e.g., radially outward) from exterior surface 510 of tool device 502 are a plurality of “modified I-beam” configured projections 512 arranged in two juxtaposed rows (R1 and R2) in non-staggered or width-wise aligned fashion; with there being four columns shown (C1, C2, C3 and C4). Thus, there is shown aligned in R1 a plurality of said modified I-beam projections 512 (e.g., 512A to 512D) that are arranged along projection row R1 and positioned with a slight gap SP adjacent a second set of similar shaped modified I-beam projections 514A to 514D in projection row R2. Between each projection column and between each projection row there is also formed valley surfacing Vs which corresponds with the exposed surface 510 of base body 504. In FIG. 36 there is further illustrated, by way of dashed lines, shadow views of a few of the opposing roller's modified I-beam projections or projection portions (612A and 612B) and how they align with the valley surfacing Vs of the roller with pattern 502P. As seen, there is a circumferentially and axial offset nested alignment arrangement between modified I-beam projections of the illustrated tool device 502 and a valley floor of the opposing roller (not shown) also having modified I-beam projections. Also, valley floors 513 represent different sections of the exterior, exposed surface 510. The individual projections 512 are shown as being circumferentially spaced apart in their extension about the illustrated cylindrical tool device 502 with suitable spacing areas to achieve the noted alignment nesting arrangement. As further seen from FIG. 36 the modified I-beam projections feature a standard I-shape first portion 554 as well as a central cross over section 555 which is integrated with the first portion 554 as to provide for a common, continuous “modified I-beam” shaped outer periphery rim section 576.

The rim projections 576 also step down in similar fashion as the earlier embodiments to define an interior projection floor recess 585 shown at a level above the valley surface floor Vs. The relative step down height and relative rim and overall projection height are preferably within the above described ranges for the other embodiments. As seen, however, the projections such as 512 are made relatively large (e.g., 2 to 6 projections per row along a circumferential track) as in about a 3 to 6 inch (e.g., about a 5 inch) circumferential length for illustrative, modified I-beam projection embodiments and with, for example, a maximum width along the second portion 555 of within 20% of the maximum circumferential length as in about a 4 inch maximum width in the modified I-beam projection 512 with these dimensions shown providing 4 projections per row as in for a diameter tool device that is within the ranges provided above (e.g., about 7.6 inches).

Moreover, the interior projection sets 512 of tool device 502 are shown arranged circumferentially in equal spaced sequence along their respective rows and come close to side by side abutment although not actually touching (see spacing SP which, relative to spacing SR along the rows is preferably smaller by a ration (SR/SP) of 6/1 to 3/1 for example). Thus, there is no offset from row-to-row across the width of a tool device as in other embodiments described above. Also, there can be seen that with the shape of the modified I-beam projection, there is achieved adjacent rows with portions of one projection extending laterally into receiving portions of adjacent projections.

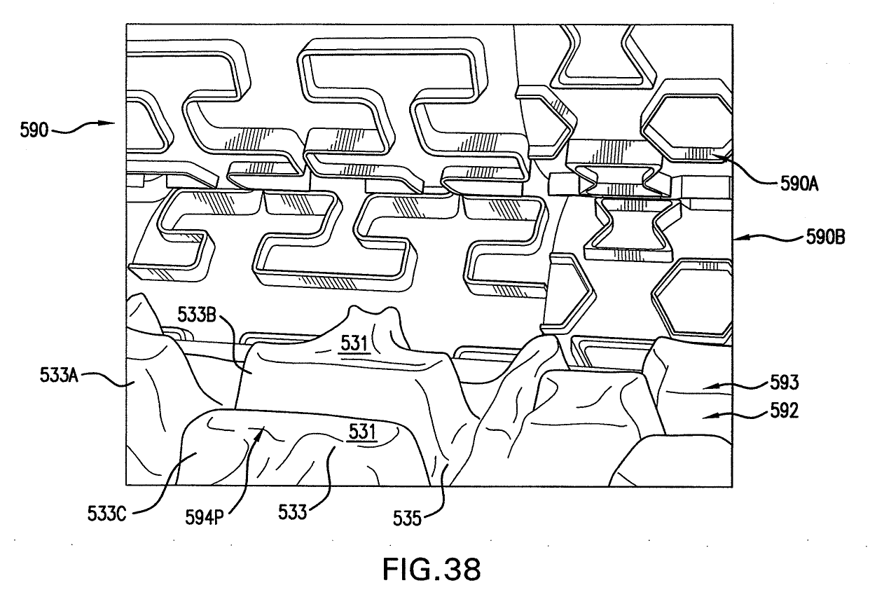

FIG. 38 shows a partial view of a tooling device assembly 590 shown in the illustrated form as comprising adjacent rollers 590A and 590B with opposing “modified I-beam” rimmed projection patterns like that discussed immediately above. FIG. 38 shows also exposed surface 593 of output product 592 (e.g., a surface pattern formed in one of two (or more) output products generated by the tooling set of rollers following cutting or splitting). Thus, with an opposing set of rollers for this “modified I-beam” tool pattern a modified I-beam projection 512 of a first roller is brought to extend toward a similarly shaped portion of the valley floor Vs of an opposing roller in the region of maximum compression within the reception gap and vice versa as shown schematically by the dashed line ghost overlay in FIG. 36. Also, in FIG. 38 there is featured the modified I-beam pattern to the left and the above-described hexagonal-hourglass combination to the right.

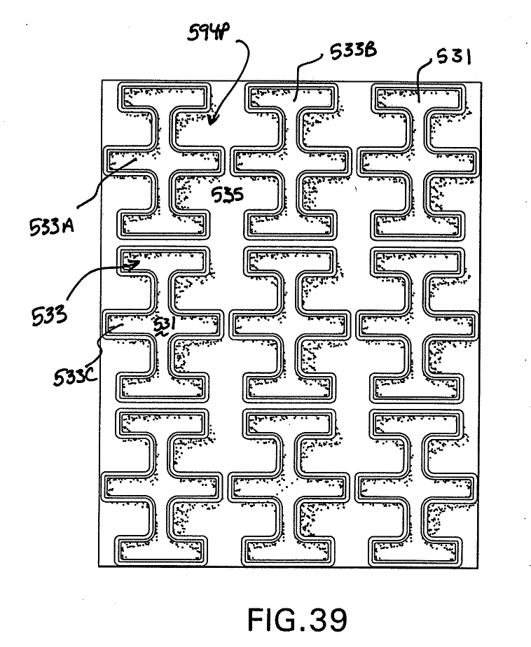

The cutting then results in surface pattern 594P in exposed surface 593 of the output product 592 shown in FIGS. 38 and 39. As seen in these Figures, the tool devices 590A and 590B result in an output product 592 having a plurality of preferably independent projections or protrusions 533 (e.g., 533A, 533B, 533C, etc.) formed over the exposed surface 593 of the output product with the modified I-beam protrusions 533 (or partial versions as at the edges) shown being dispersed and surrounded by valley regions 535. As further seen the modified I-beam shaped protrusions 533 each present essentially flat exposed uppermost surface 531 (having similar flat top characteristics as in, for example, a slight concavity in the uppermost protrusion surface).

From the foregoing it can be seen that there is provided a plurality of different tool devices or profile tool means with projection configurations that present stepped down projection recess floors, which, coupled with a variety of rim or the like profile configurations, allows for ready profiling of compressible material with the avoidance of hill top or bulbous projection peaks without post flattening processing requirements. The rim configurations and spacing arrangements are illustrative of embodiments of the tool devices or profile tooling means featured under the present invention but the current invention is not meant to be limited to the same.

Under a method of profiling a compressible material, a slab of material (e.g., a layer of foam) is fed to a profiler (e.g., fed on a conveyor track system or sliding surface such as that shown in FIG. 1) with a preferred embodiment having the tooling means (e.g., a set of tooling devices such as sets 90, 290, 390 and 490 described above) preferably draw in the slab by way of the relative counter-rotation of the tooling devices although alternate embodiments include alternate means for driving the compressible material relative to the blade (e.g., independent slab material feeding means with the profiling means acting independently as in grasping means for pulling the slab and output product(s)). The drawn in compressible layer of slab of material is then subjected to compression effect of the respective, opposing tool devices' smaller gap spacing than the initial thickness of the fed material. The relative tooling patterns thus position the compressed foam within the respective general valley floor cavities (going in one radial direction) while at the same time foam is forced into a projection recess floor cavity defined by the rim means (e.g., individual encircled rim regions with step downs or parallel running rim walls forming projection recess floors therebetween). The projection recess floors are at a radial height that is out away from the exposed valley floor and the projection's rim is further radially spaced out away from the projection recess floor such that a projection rim forces more foam across the cutting edge plane and into a corresponding valley floor cavity than an amount partially compensated for in a channel or recess defined by the step down projection reception floor (channel or recess) provided at an exposed free or distal end of the tooling projections involved.

Thus, with the relative projection/valley and projection recess floor positioned within the confines of that same valley of the opposing tool and a cutting of the compressible material while in a compressed state (or other means of separation to achieve the surface patterning described herein) there is achieved output product(s) having a desired surface pattern which is inclusive of flat or essentially flat top protrusions (e.g., essentially flat top foam body protrusions separated by foam base valleys) or generally flat top as when an intentional concavity extension is implemented rather than a slight concavity.

Under a method of assembling a profiler there is provided a first tooling device and a second tooling device (as in a pair of tooling rollers with each having a stacked set of profile tool devices or tooling rings, or each being a single profiled surface roller or a combination of the two types). The first and second tooling devices are provided with respective tooling patterns preferably comprised of a set of projections spaced apart from one another by tooling body valley floors. Also, at least some of the respective projections of the tooling devices are provided with rim extensions designed to provide projection recess valley floor regions therewithin. The tool devices are arranged as to have the projections in one tooling set (with associated projection recess floors) align with the tool device pattern of the other tool device as to achieve at least a generally flat top configuration in the protrusions provided in the one or more output product surface patterns generated.

What is claimed is:

1. A compressible material profile forming tool device, comprising:
a base body having an exterior surface;
a plurality of projections which extend off from said base body to form a plurality of valleys between said projections, which valleys are defined in part by valley floors formed by respective exposed regions of the exterior surface of said base body, said projections each having an upper projection recess which is defined by an exposed projection recess floor and at least one projection rim extending along the exposed projection recess floor, and the exposed projection recess floor of said projections being at a height above an adjacent valley floor.

2. The tool device of claim 1, wherein said tool device is a rotatable tool with the exposed surface of said base body having a continuous outer profile with curvature.

3. The tool device of claim 2, wherein said base body has a cylindrical configuration with said projections extending radially out from the exterior surface.

4. The tooling device of claim 3, wherein said base body is defined by a plurality of rows of projections in a side-by-side arrangement with each of said rows having some of said plurality of projections and wherein the projections on said base body include at least two types of projection with a first of said types having an annular rim set defining a projection recess floor therebetween and valley floor to opposite sides of said annular rim set and the second type having a single annular rim wall with a projection recess floor internal to that single annular rim wall, and said single annular rim wall having an exterior configuration which is surrounded by valley floor and sized as to allow for insertion into an interior rim wall of said first projection type from a dimension standpoint.

5. The tool device of claim 1, wherein said projections are arranged in at least one repeating pattern over the exposed surface of said base body.

6. The tool device of claim 5 wherein said projections each have an encompassing rim configuration that extends around a respective projection recess floor.

7. The tool device of claim 6 wherein said rim configuration includes a multi-sided rim configuration.

8. The tool device of claim 7, wherein said rim configuration includes a square rim configuration with a square shaped projection recess floor.

9. The tool device of claim 7, wherein said multi-sided rim configuration includes straight and curved rim wall sections.

10. The tool device of claim 9 wherein the rim configuration includes a square convex rim configuration.

11. The tool device of claim 8, wherein the rim configuration includes a modified I-beam configuration.

12. The tool device of claim 8, wherein said rim configuration includes both an hourglass rim configuration and a hexagonal rim configuration.

13. The tool device of claim 1, wherein each said projection includes opposite side rim walls forming a channel shaped, exposed projection recess between said opposite side rim walls.

14. The tool device of claim 13, wherein said base body has a continuous outer profile with curvature and said rim walls defining said channel shaped, exposed projection recesses extend continuously about the continuous outer profile of the base body.

15. The tool device of claim 13, wherein the opposite rim walls extend in a wavy pattern about the base body and adjacent projections are spaced apart along a width of said base body to a greater extent than a width of one of the channels defined by said adjacent opposite rim walls.

16. The tool device of claim 13, wherein the projection recess floor is positioned closer to said valley floor than an upper edge of one of said rim walls.

17. The tool device of claim 1, wherein there are a plurality of projections with different rim configuration patterns provided on said base body, wherein projections of a first type comprise a first rim configuration pattern that comprises a wavy pattern configuration and projections of a second type comprise a second rim configuration defining a multi-sided rim configuration that encloses respective projection recess floors.

18. The tool device of claim 1, wherein at least some of said projections have an encompassing rim configuration that continuously extends around the projection recess floor, and wherein said encompassing projections have a ratio (hr/hp) of rim height (hr) to projection height (hp) that is from 35-80%.

19. The tooling device of claim 1, wherein said tool device has an annular configuration and said rim is defined by a pair of opposing rim walls that extend in spaced apart fashion continuously about the annular configured tool device to define a channel as the projection recess floor with the ratio hr/hp of rim wall height to projection height being 35-80%.

20. The tool device of claim 1, wherein across a width direction of said tool device there is a sequence of first valley floor—first projection rim section—projection recess floor—second projection rim section—second valley floor, with said projection recess floor being at a higher level relative to each of the first and second valley floors.

21. The tool device of claim 20, wherein the tool device has a circular outer periphery such that the width direction is parallel with an axis of rotation in said tool device and wherein, along a circumferential path, there is a sequence of third valley floor—third projection rim section—projection recess floor—fourth projection rim section and fourth valley floor.

22. A compressible material profiler, comprising a first tooling device which includes one or more of the tool devices of claim 1; a second tooling device; a support assembly which supports said first and second tooling devices as to define a compressible material reception gap between said first and second tooling devices; a cutting device positioned to cut the input material as to produce first and second output products with at least one output product having a surface profile pattern.

23. The profiler of claim 22, wherein said second tooling device also includes one or more of the tool devices of claim 1 as to provide a compressible material contact section with corresponding projection patterning as that of said first tooling device, and said first and second tooling devices are arranged to have an interfacing section with valleys of said second tooling device aligned with projections of said first tooling device in a region of the reception gap.

24. The profiler of claim 22, wherein said first and second tooling devices are configured to form in compressible material fed within the reception gap an output product with essentially flat top projection surfacing.

25. The profiler of claim 22 wherein the first and second tooling devices are configured as to define a plurality of foam protuberances in an output product with each having an essentially flat upper exposed surface and adjacent valley floors with each valley floor also having an essentially flat exposed surface.

26. The profiler of claim 25, wherein said first and second tooling devices are configured to define slight concavities in the essentially flat upper exposed surface of said protuberances.

27. The profiler of claim 22, wherein said profiler is a compressible foam profiler that forms one or more output products having generally flat top surfacing upon recovery from a cutting operation performed in or adjacent the reception gap.

28. A method of profiling compressible material, comprising:
feeding a slab of compressible material through a reception gap formed between one or more of the tool devices of claim 1, as a first tooling device, and a second tooling device spaced from the first tooling device so as to compress the slab;
cutting the slab material while compressed by said first and second tooling devices as to form at least one output product having an essentially flat top surface pattern formed thereon.

29. The method of claim 28, wherein the slab material comprises a foam material, and said second tooling device has a projection section having a common projection configuration and pattern as that of a projection section of said first tooling device and with projections of said first tooling device being arranged to correspond with valleys of said second tool device within a region of said reception gap such that there is formed first and second output products with one or more sections of said first and second output products having mirror image foam protuberance and recess surface patterns.

30. The method of claim 29, wherein said first and second tooling devices are configured to form essentially flat top surfacing in a free end of the projections formed in the compressible material which includes essentially planar distal ends of the projection with concavities in an interior area region of said distal ends.

33. The method of example 28, wherein said first and second tooling devices include two different types of projection sets with a first of said types having an annular rim set defining a projection recess floor therebetween and valley floor to opposite sides of said annular rim set.

34. The method of claim 33 wherein there are two different types of projection types on each of said first and second tooling devices and the second projection type includes an annular single rim configuration with an interior projection recess floor, which second projection type is dimensioned for nesting relationship within an interior rim wall of said first type.

35. The method of claim 28 wherein each tooling device includes a common configured projection pattern which are relatively offset so as to form a nesting relationship which is inclusive of an overlapping relationship along a direction of extension of the tooling devices.
